(19) United States
(12) Patent Application Publication
(10) Pub. No.: US 2014/0095125 A1
(43) Pub. Date: Apr. 3, 2014

(54) METHOD AND SYSTEM FOR REDUCING COMPUTATIONAL EFFORT FOR SOLVING A MODEL OF A REAL-WORLD SCENARIO

(71) Applicant: DEUTSCHE BÖRSE AG, Eschborn (DE)

(72) Inventor: Herbert NACHBAGAUER, Usingen (DE)

(73) Assignee: Deutsche Borse AG, Eschborn (DE)

(21) Appl. No.: 13/631,124

(22) Filed: Sep. 28, 2012

(51) Int. Cl. G06F 17/50

(52) U.S. Cl. CPC G06F 17/5009
USPC 703/2

(57) ABSTRACT

A computer-implemented method for reducing a computational effort of finding a solution of a first model modeling a real-world scenario is presented. The first model has model variables and is defined by a set of rules comprising a first subset of rules and a second subset of rules, wherein each rule of the set of rules defines at least one condition for at least one model variable. A set of relaxed rules is built by relaxing each rule of the first subset of rules of the first model, wherein relaxing a rule comprises modifying at least one condition of said rule. Further, an initial model is constructed using the set of relaxed rules and the second subset of rules. A solution of the initial model is computed, wherein the solution of the initial model is a set of model variables satisfying each rule defining the initial model. For each rule in the first subset of rules, it is determined if the solution of the initial model satisfies the rule. If the solution of the initial model does not satisfy the rule, a cut for the rule is determined and the cut is stored in a set of initial possible cuts of the initial model, wherein a cut is a constraint on at least one model variable of the rule. If the set of initial possible cuts of the initial model is empty, the solution of the initial model is stored as a solution of the first model.

### BACKGROUND OF THE INVENTION

The invention relates to data processing apparatus and methods and, more particularly, to an algorithm for solving a model of a real-world scenario.

Nowadays, many real-world scenarios of natural science such as physics, biology, earth science and meteorology, of engineering disciplines such as computer science or artificial intelligence, of social science such as economics, psychology, sociology and of political science are translated into mathematical models (also referred to as models) to better understand real-world effects and to make predictions as to the future behavior. A mathematical model describes the real-world scenario by a set of model variables (also referred to as variables) and a set of rules (expressed by equations and inequations on the model variables) that establish conditions for the model variables. The actual mathematical model is the set of rules that describe the relations between the different model variables and define conditions or constraints for the model variables.

Solving mathematical models that have been developed for real-world scenarios is a common activity and one that demands a wide range of computer based numerical techniques. Few problems can be solved analytically and hence numerical computation dominates the field. By modeling a real-world scenario, a trade-off between the complexity of the model and computability of a solution of the model has to be made. While added complexity usually improves the realism of the model, it makes the model more difficult to understand and increases the computational load for finding a solution of the model considerably.

However, many models for real-world scenarios need a certain degree of complexity in order to be useful in predicting or understanding the behavior of the real-world scenario. This holds especially true for modeling problems for which the goal is to compute the best solution. In many cases, solutions of the models need to be computed as fast as possible or within a limited calculation time.

### SUMMARY OF THE INVENTION

An improved algorithm is provided which reduces the computational effort of solving a model of a real-world scenario.

In an embodiment, a computer-implemented method for reducing a computational effort of finding a solution of a first model modeling a real-world scenario is provided. The first model has model variables and is defined by a set of rules comprising a first subset of rules and a second subset of rules, wherein each rule of the set of rules defines at least one condition for at least one model variable. A set of relaxed rules is built by relaxing each rule of the first subset of rules of the first model, wherein relaxing a rule comprises modifying at least one condition of said rule. Further, an initial model is constructed using the set of relaxed rules and the second subset of rules. A solution of the initial model is computed, wherein the solution of the initial model is a set of model variables satisfying each rule of the initial model. For each rule in the first subset of rules, it is determined if the solution of the initial model satisfies the rule. If the solution of the initial model does not satisfy the rule, a cut for the rule is determined and the cut is stored in a set of initial possible cuts of the initial model, wherein a cut is a constraint on at least one model variable of the rule. If the set of initial possible cuts of the initial model is empty, the solution of the initial model is stored as a solution of the first model.

According to another embodiment, a computer-readable medium has computer-executable instructions that, when executed by a computer, cause the computer to perform a method for reducing a computational effort of finding a solution of a first model modeling a real-world scenario. The first model has model variables and is defined by a set of rules comprising a first subset of rules and a second subset of rules, wherein each rule of the set of rules defines at least one condition for at least one model variable. A set of relaxed rules is built by relaxing each rule of the first subset of rules of the first model, wherein relaxing a rule comprises modifying at least one condition of said rule. Further, an initial model is constructed using the set of relaxed rules and the second subset of rules. A solution of the initial model is computed, wherein the solution of the initial model is a set of model variables satisfying each rule of the initial model. For each rule in the first subset of rules, it is determined if the solution of the initial model satisfies the rule. If the solution of the initial model does not satisfy the rule, a cut for the rule is determined and the cut is stored in a set of initial possible cuts of the initial model, wherein a cut is a constraint on at least one model variable of the rule. If the set of initial possible cuts of the initial model is empty, the solution of the initial model is stored as a solution of the first model.

Finally, a computer system is provided which comprises a memory having stored computer-executable instructions and a processor which is configured for executing the stored computer-executable instructions. The computer-executable instructions cause the processor to perform a method for reducing a computational effort of finding a solution of a first model modeling a real-world scenario. The first model has model variables and is defined by a set of rules comprising a first subset of rules and a second subset of rules, wherein each rule of the set of rules defines at least one condition for at least one model variable. A set of relaxed rules is built by relaxing each rule of the first subset of rules of the first model, wherein relaxing a rule comprises modifying at least one condition of said rule. Further, an initial model is constructed using the set of relaxed rules and the second subset of rules. A solution of the initial model is computed, wherein the solution of the initial model is a set of model variables satisfying each rule of the initial model. For each rule in the first subset of rules, it is determined if the solution of the initial model satisfies the rule. If the solution of the initial model does not satisfy the rule, a cut for the rule is determined and the cut is stored in a set of initial possible cuts of the initial model, wherein a cut is a constraint on at least one model variable of the rule. If the set of initial possible cuts of the initial model is empty, the solution of the initial model is stored as a solution of the first model.

### BRIEF DESCRIPTION OF THE DRAWINGS

The accompanying drawings are incorporated into and form a part of the specification for the purpose of explaining the principals of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1 illustrates a flow chart of an algorithm for finding a solution of a model modeling a real world scenario by solving simplified models according to an embodiment;

FIG. 2 is a block diagram illustrating a model for which a solution is desired and modified models which help to find the solution of the model according to an embodiment;

FIG. 3 illustrates a flow chart of determining a current best solution of a model modeling a real world scenario according to an embodiment;

FIG. 4 shows a flow chart illustrating an algorithm for modifying a model in order to find a solution of a model modeling a real world scenario according to an embodiment;

FIG. 5 shows a block diagram illustrating how to find a solution of a welfare model with the help of a continuous model and a relaxation model according to an embodiment of the invention; and

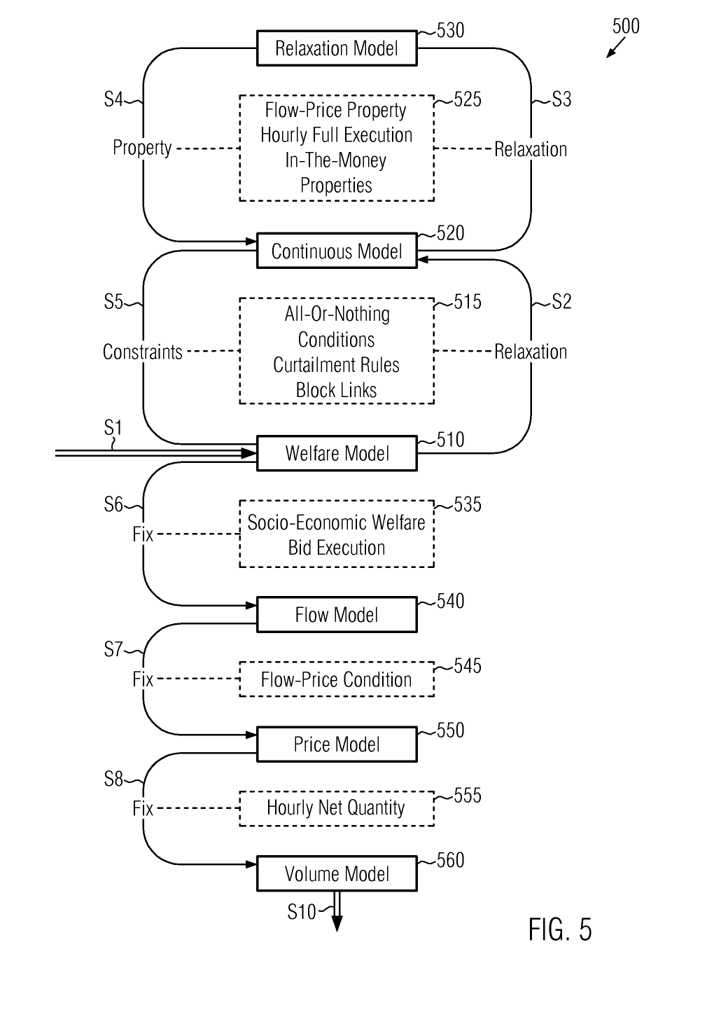

FIG. 6 is a schematic block diagram of a computer architecture for performing the disclosed methods.

### DETAILED DESCRIPTION OF THE INVENTION

The illustrative embodiments of the present invention will be described with reference to the figure drawings wherein like elements and structures are indicated by like reference numbers.

A mathematical model describing a real-world scenario usually describes a system by a set of variables and a set of equations and inequations. Rules establish relationships between the variables and/or defining conditions for the variables. A solution of the mathematical model is a set of variable values which satisfies each equation and inequation building the mathematical model. The present invention aims at providing an algorithm which finds a solution for a complex model of a real world scenario in an efficient, reliable and fast manner.

### I General Overview

The present invention is firstly described in a general overview where a real-world scenario is modeled by a first model for which a solution is desired. The first model has model variables and is defined by a set of rules. Each rule of the set of rules defining the first model can be expressed as a set of mathematical equations and/or inequations which define at least one condition for at least one variable of the model. Generally, the set of rules comprises a first subset of rules and a second subset of rules. The present invention aims at finding an optimal solution of the first model, wherein a solution of the first model is a set of variable values which satisfies each rule of the set of rules defining the first model and the optimal solution is the best solution of all feasible solutions. Specifically, the present invention aims at finding as fast as possible a solution, the current best solution, of the first model which is as close as possible to the optimal solution. The time for computing the current best solution is significantly shorter than the time for computing the optimal solution using conventional techniques.

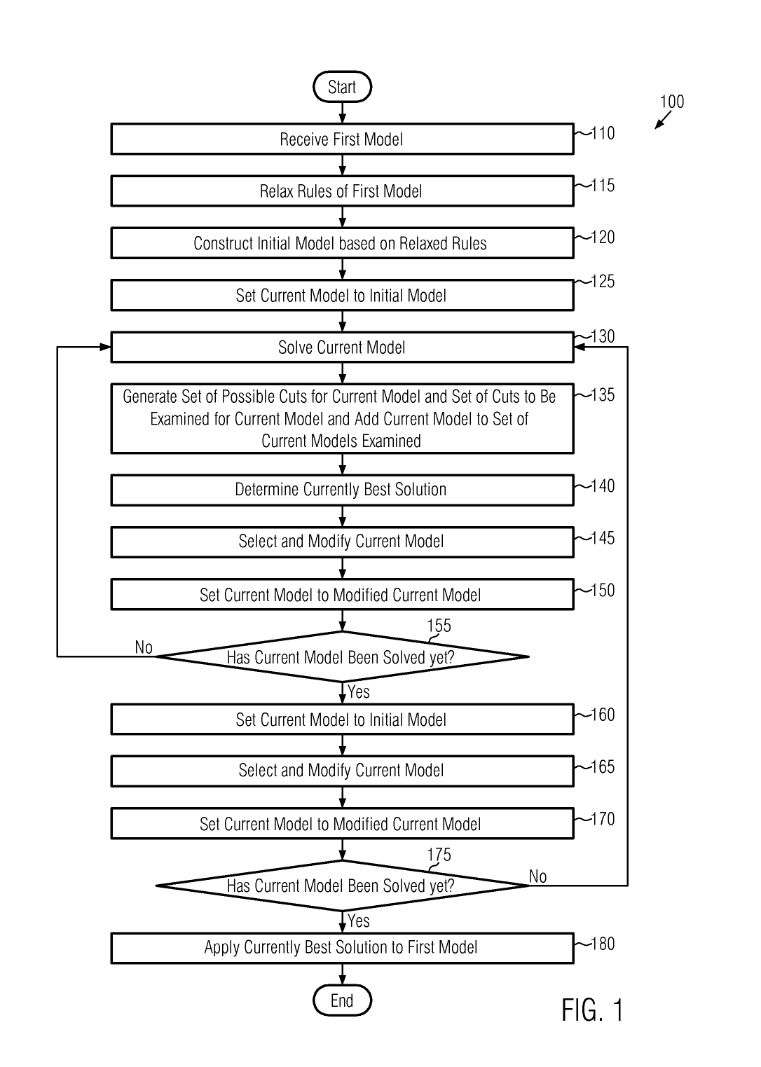

FIG. 1 illustrates a flow chart of finding the current best solution of the first model according to an embodiment of the present invention. Briefly, the first model is modified to a first simplified model, referred to as the initial model. A solution of the initial model is computed by conventional means. If the solution of the initial model is not a solution of the first model, additional constraints are defined and a new model, referred to as the current model, is built. The current model is defined by the rules of the initial model and the additional constraints. A solution of the current model is computed. If the solution of the current model is not a solution of the first model, the current model or a previously considered current model is further restricted by new additional constraints. The new current model is set to be the restricted current model which is solved. This process is performed recursively.

In some embodiments it may additionally be determined whether the solution of the current model is better than a solution of a previously considered current model to further reduce the computational effort, wherein the solution of the previously considered current model is a solution of the first model. If the solution of the current model is worse than the solution of the previously considered current model, the current model will not further be constrained and it may be returned to the initial model which is modified by new constraints.

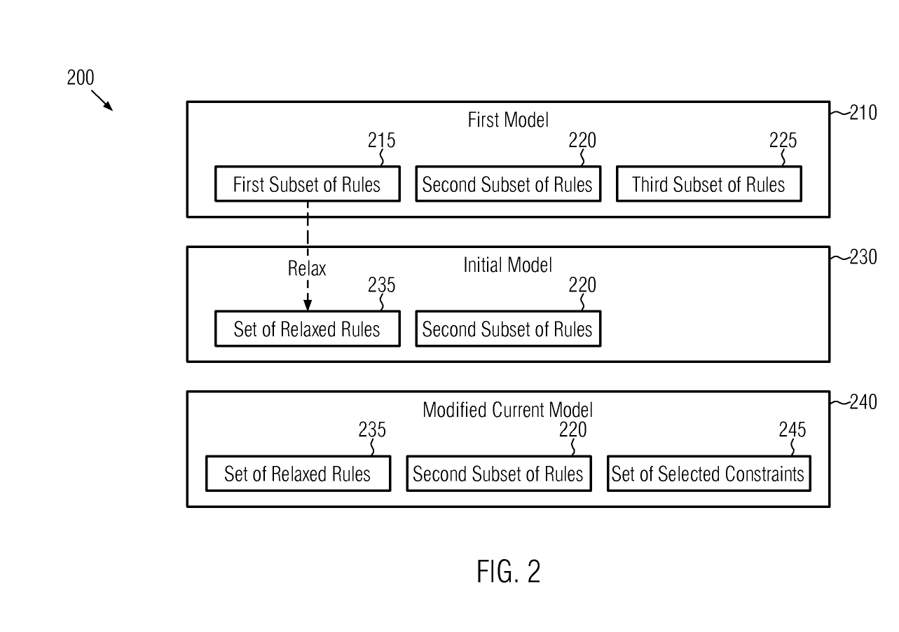

Referring to FIG. 1 and FIG. 2, details of the briefly sketched idea will now be described. The method of FIG. 1 is also referred to as multibranch algorithm and will be described in even more detail in chapter II.7.1.3. At step 110, the first model 210 is received. As outlined above, the first model 210 has a set of model variables and is defined by a set of rules wherein each rule defines at least one condition for at least one model variable. Each rule can be expressed as a set of mathematical equations and inequations defining at least one condition for at least one model variable. The first model 210 may comprise a first subset of rules 215 and a second subset of rules 220. In some embodiments, the first model 210 further comprises a third subset of rules 225 defining objective functions for the first model. The third subset of rules may not introduce new model variables.

At step 115, rules of the first model 210 are relaxed. According to an embodiment of the present invention, each rule of the first subset of rules 215 is relaxed to generate a set of relaxed rules 235. Relaxing a rule comprises modifying at least one condition of the rule which is relaxed. Specifically, relaxing a rule softens the rule with regard to computational effort of finding solutions of the rule. For instance, a rule may define a condition for a model variable restricting the model variable to an integral value. Relaxing this rule may be performed by modifying the condition to allow non-integral values for that model variable of the rule.

At step 120, an initial model 230 is constructed using the set of relaxed rules 235 and the second subset of rules 220. Accordingly, the initial model 230 is defined by the set of relaxed rules 235 which has been built by relaxing each rule of the first subset of rules 215 of the first model 210 and the second subset of rules 220 of the first model. In some embodiments, the set of relaxed rules 235 and the second subset of rules 220 define conditions for each model variable of the first model 210. In those embodiments, the third subset of rules merely defines additional conditions for the model variables and may not introduce new model variables.

The initial model 230 differs in two ways from the first model 210: firstly, for those embodiments where the first model comprises a third subset of rules 225, this third subset of rules 225 is not considered for the initial model 220 and secondly, each rule of the first subset of rules 215 is relaxed to define the set of relaxed rules 235. According to embodiments of the present invention, rules of the third subset of rules 225 define objective functions which need to be optimized, i.e. either maximized or minimized.

The following steps 130 to 155 of FIG. 1 are performed recursively. In order to describe the recursive nature of this method, a current model is defined which is set to the initial model at step 125. Accordingly, in the first pass of steps 130 to 155, the initial model is considered since the rules defining the current model in the first pass are the rules of the initial model.

At step 130, a solution of the current model is computed by conventional numerical and/or analytic methods which are well known to a person skilled in the art. As the current model is defined by considerably less rules than the first model 210 for embodiments where the first model 210 comprises a third subset of rules 225 and a number of rules of the current model has been additionally relaxed, the computational load on the computer system solving the current model is less than the computational load on the computer system directly solving the unmodified first model 210.

At step 135, it is determined if the solution of the current model solves the first model 210. In particular, it is determined whether the found solution of the current model satisfies each rule of the first subset of rules of the first model 210. If it is determined that the solution of the current model does satisfy each rule in the first subset of rules 215, the solution of the current model is also a solution of the first model. In this case, a set of possible cuts for the current model and a set of cuts to be examined for the current model are set to empty sets.

In case the solution of the current model does not satisfy each rule of the first subset of rules 215, it is determined which of the rules of the first subset of rules 215 are violated by the solution of the current model. For each rule which is not satisfied by the solution of the current model, a so-called cut is determined. A cut is one or more additional constraints on at least one model variable of the rule. For instance, as described above, in some embodiments there may be rules in the first subset of rules 215 which restrict model variables to integral values. In those embodiments, the set of relaxed rules 235 may be built by allowing non-integral values for those variables. Those variables which are restricted to integral values are referred to as execution variables. Accordingly, if the solution of the current model found at step 130 is not a solution of the first model, i.e. not all rules of the first subset of rules 215 are satisfied by the solution of the current model, all execution variables of the solution of the current model may be identified which have a non-integral value. In those embodiments, for each identified execution variable which has a non-integral value, an additional constraint may be generated which sets the identified execution variable to an integral value. More details on cuts will be given in section II.7.

The determined cuts are stored in a set of possible cuts for the current model. In addition, a set of cuts to be examined for the current model is generated. The set of cuts to be examined for the current model may be initialized with the elements of the set of possible cuts for the current model. Obviously, if the set of possible cuts is empty, the solution of the current model is a solution of the first model, too.

To uniquely identify a specific model which has already been examined, the current model is saved together with its defining parameters in a set of current models examined. The defining parameters are additionally selected constraints, the set of possible cuts for the current model, the set of cuts to be examined for the current model and the solution of the current model. The set of the additionally selected constraints will be further explained below with reference to step 145 since in the first pass of steps 130 and 135 the initial model is considered where the set of additionally selected constraints is empty.

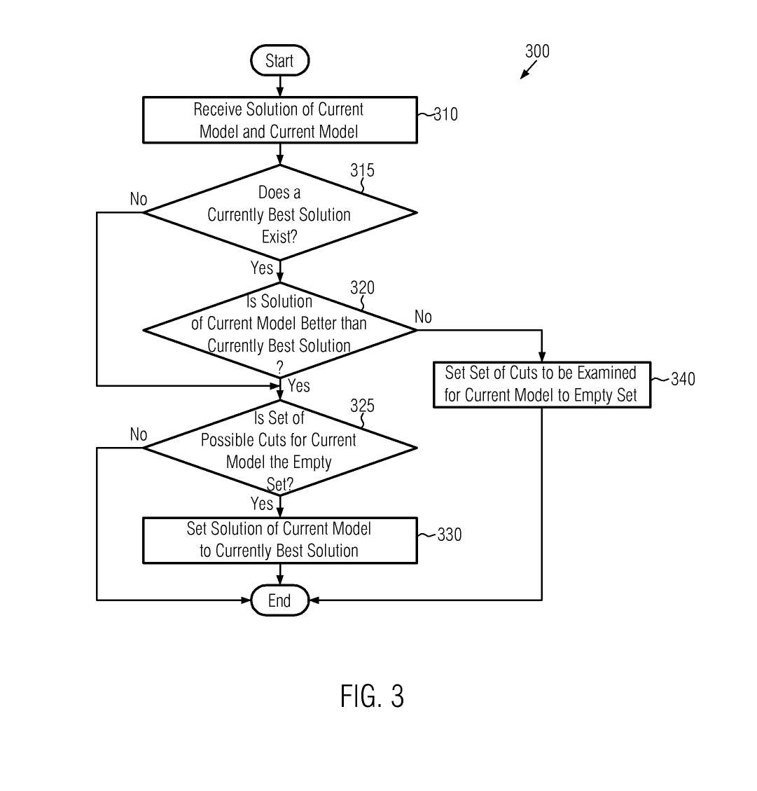

At step 140, it is determined whether the solution of the current model is the current best available solution. Details on this step 140 will be described in the following with reference to FIG. 3.

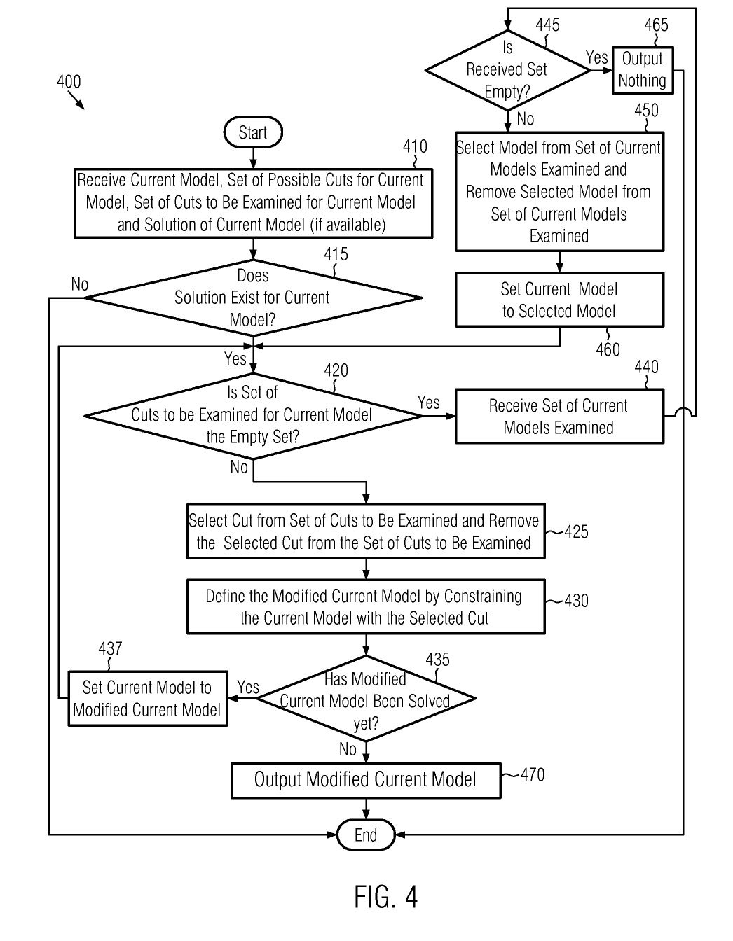

At step 145, the current model is modified to a modified current model 240. In some cases, one or more cuts from the set of cuts to be examined for the current model are selected and the current model is additionally constrained by the constraints of those selected cuts. The set of cuts to be examined for the current model is updated by removing the selected cuts from the set of cuts to be examined for the current model. Further, the constraints of the selected cuts are added to the set of additionally selected constraints 245 for the modified current model. Accordingly, the modified current model 240 is defined by the set of relaxed rules 235, the second subset of rules 220 and the set of additionally selected constraints 245. In other cases, after the first pass of steps 130 to 155, another current model may be selected from the set of current models examined, and modified. More details on step 145 will be described with regard to FIG. 4 below.

At step 150, the current model is set to the modified current model, i.e. the current model is now defined by the rules and constraints of the modified current model of step 145.

At step 155, it is determined whether the current model has been solved yet. To this purpose, the solution of the current model and the set of additionally selected constraints of the current model are compared to the respective solutions and sets of additionally selected constraints of the models stored in the set of current models examined.

If it is determined at step 155 that the current model has not been solved yet, the method returns to step 130 and steps 130 to 155 are performed for the current model. If it is determined at step 155 that the current model has been solved, the method branches to step 160 where the current model is set to the initial model, i.e. the current model is defined by the rules of the initial model.

At step 165, the current model is modified as described with regard to step 145 and in accordance with the description of FIG. 4. At step 170, the current model is set to be the modified current model, i.e. the current model is now defined by the rules and constraints of the modified current model of step 165. At step 175, it is determined whether the current model has been solved yet. If the current model has not been solved yet, the method returns to step 130. However, if the current model has been solved, the current best available solution may be considered to be the solution of the first model and may be applied at step 180 to the first model to model the real world scenario.

More details on steps 110 to 180 will be given below in sections II.7 where the so-called multi-branch algorithm is described.

To describe step 140 in more detail, it is now referred to FIG. 3 which is a flow chart of determining the current best solution. At step 310, the defining parameters of the current model may be received. The defining parameters of the current model are the set of possible cuts of the current model, the set of cuts to be examined for the current model the additionally selected constraints of the current model and the solution of the current model.

At step 315, it is determined if a current best solution exists. If no current best solution exists, the method branches to step 325. If a current best solution exists, it is determined at step 320 if the solution of the current model is better than the current best solution. If it is determined at step 320 that the current best solution is worse than the solution of the current model, the method branches to step 325 where it is determined if the set of possible cuts for the current model is the empty set. If the set of possible cuts for the current model is the empty set, the solution of the current model is also a solution of the first model as described above. If it is determined at step 325 that the set of possible cuts for the current model is the empty set, the current best solution is set to be the solution of the current model and may be stored.

If it is determined at step 325 that the set of possible cuts for the current model is not the empty set, the method does not set the solution of the current model to be the current best solution and returns.

Returning to step 320, if it is determined that the solution of the current model is worse than the current best solution, the set of cuts to be examined for the current model is set to be the empty set and stored together with the other defining parameters of the current model. Accordingly, step 340 is performed to further save computational load since the branch of models which return a solution worse than a current best available solution is no longer considered. This will become more apparent when discussing FIG. 4.

According to some embodiments, the solutions of all models stored in the set of current models examined may be compared to the current best solution and for each model having a solution worse than the current best solution, the set of cuts to be examined of the respective model may be set to the empty set.

Referring now to FIG. 4 and describing thereby steps 145 and 165 of FIG. 1 in more detail, at step 410, the current model and its respective defining parameters, i.e. its set of possible cuts, its set of cuts to be examined, and its additional constraints and, if available, the solution of the current model is received. At step 415, it is determined whether a solution for the current model exists. Specifically, in some cases, the current model may not be solvable by conventional techniques, no solution may exist in a mathematical sense, or the time for computing a solution may exceed a threshold time span. In those cases, no solution is available and the method ends. However, if it is determined at step 415 that a solution for the current model exists, the method proceeds to step 420 where it is determined if the set of cuts to be examined for the current model is the empty set.

If the set of cuts to be examined for the current model is the empty set, the method proceeds to step 440 where the set of current models examined is received. If the set of current models examined is the empty set, the method of FIG. 4 outputs nothing and ends. If, however, the received set of current models examined is not empty, a model is selected at step 450 from the set of current models examined and the set of current models examined is updated by removing the selected model from the set of current models examined. At step 460, the current model is set to be the selected model from the set of current models examined and the method returns to step 420.

If, however, it is determined at step 420 that the set of cuts to be examined for the current model is not the empty set, one or more cuts from the set of cuts to be examined is selected at step 425 and the set of cuts to be examined is updated by removing the selected one or more cuts from the set of cuts to be examined.

At step 430, a modified current model is defined by constraining the current model with the selected one or more cuts. Specifically, the constraints of the selected one or more cuts are added to the set of additionally selected constraints. At step 435, it is determined whether the modified current model has been solved yet. If the modified current model has been solved, the method proceeds to step 437 where the current model is set to be the modified current model and the method returns to step 420. If the modified current model has not been solved yet, the modified current model is output at step 470.

According to embodiments, the steps of storing the solution of the current model as a solution of the first model may comprise the steps of: 1) determining at step 315 if a solution of the first model has been stored; 2) if a solution of the first model has been stored, determining at step 320 if the solution of the current model is better than the stored solution of the first model; and 3) if the solution of the current model is better than the stored solution of the first model, replacing at step 330 the stored solution with the solution of the current model.

According to embodiments, if the solution of the current model is not better than the stored solution, the current model is set to be the initial model at step 160 and the method proceeds with step 165.

### II Specific Description: An Area Coupling Model—a Hybrid Model

In the following, an embodiment is described where the first model 210 is implemented as a Hybrid Model (see II.5.2). The initial model 230 is implemented as a Relaxation Model (see II.5.3.3) and the current models, which are built from the initial model, are implemented as Cut Relaxation Models (see, for instance II.7.1.3.9.8). Further, the model defined by the first subset of rules 215 and the second subset of rules 220 is implemented as a Welfare Model 510 (see II.5.3.1).

### II.1 Introduction

Trading of non-fungible products like electric power or natural gas brings together two aspects: Business rules for the trading of commodities, and physical transport, storage and delivery constraints. It is economically reasonable to account for both aspects in an integrated market model, and to perform price fixing in an implicit auction.

The scenario considered in this specific embodiment primarily reflects the situation encountered in day-ahead trading of electric power. With modifications, it may also be applicable to other non-fungible commodities as well.

Physically, the market consists of geographical regions where market participants deliver or produce electric power. From a business perspective, buyers and sellers place their orders in the respective market area. It is an implicit presumption in the market model that power can be distributed within an area without any physical constraints or extra cost, such that local buy and sell orders can be matched directly.

On the other hand, transport of electric power between market areas is subject to physical capacity constraints. Area coupling is an implicit mechanism for both matching bids in market areas and the allocation of inter-area capacity in an integrated auction. Implicit coupling does improve the efficiency of markets. The objective is to maximize the overall socio-economic welfare. All profitable trades resulting from the matching of buy and sell offers will be executed.

This specific embodiment describes the area coupling model, coupling rules and the auction algorithm.

Market coupling, as it is described here, refers to pure ATC, available transport capacity, coupling. In that case, cross border capacities are constraint by absolute minimal and maximal values per hour, as well as probably ramping constraints.

### II.2 Market Data

### II.2.1 Units

The unit for quantities and flows is MW. The unit for prices is [symbol] /MW. The unit for socio-economic welfare and congestion rent is [symbol] . Input quantities are represented in multiples of 0.001 MW, 0.01 [symbol] /MW and 0.01 [symbol] , respectively. Numbers are calculated with double precision, and rounded if necessary. Though of interest for the actual auction calculation, units are not explicitly used in this specification.

### II.2.2 Delivery Hours

A delivery hour refers to one physical hour of the delivery day, starting on the hour every hour. The calculation is usually performed for 24 consecutive delivery hours of the delivery day, with the exception of the daylight saving time shift day, which comprises 23 and 25 delivery hours, respectively. The timely sorted set of delivery hours will be denoted by H.

### II.2.3 Market Areas

Market areas model the geographic areas in which bids can be entered. The set of market areas will be denoted with A. Every market area aεA has a minimum price limit pₐ⁻ and maximum price limit pₐ⁺. The minimum of the limits pₐ⁻ is the global minimum price limit p⁻=min_{aεA} pₐ⁻. The maximum of the limits pₐ⁺ is the global maximum price limit p⁺=max_{aεA} pₐ⁺.

A market area contains exactly one buy and one sell hourly bid per delivery hour (see II.2.4.1).

### II.2.4 Bids

Every bid is associated with one market area. Depending on the bid type, bids carry price and quantity attributes. By convention, buy bids are characterized by non-negative quantities and sell bids by non-positive quantities. Various bid types are supported.

### II.2.4.1 Hourly Bids.

An hourly bid models the intention to buy or sell a price dependent quantity in a certain market area, and in a particular delivery hour. The price-quantity dependence of an hourly bid is defined by a set of interpolation points C and modeled by a bid curve ζ (see appendix A).

The list of the interpolation price-quantity points of a bid curve of the hourly bid in area aεA and hour hεH is denoted by C_{a,h}=((p_{a,h,i}|q_{a,h,i})|i=0, . . . , n_{a,h}−1) where n_{a,h} is the number of bid curve points. The bid curve must start at the minimum price and end at the maximum price of the market area the hourly bid belongs to. A valid bid curve satisfies p_{a,h,0}=pₐ⁻ and p_{a,h,n}_{_{a,h}}₋₁=pₐ⁺.

Bid curve interpolation points must represent a monotonically decreasing sequence. The quantity q_{a,h}⁺=q_{a,h,0} of the first interpolation point is the maximal, and q_{a,h}⁻=q_{a,h,n}_{_{a,h}}₋₁ of the last interpolation point is the minimal quantity of the bid curve. Buy bid curves have interpolation points with non-negative quantities, q_{a,h,i,B}≧0, sell bid curve interpolation points have non-positive quantities q_{a,b,i,S}≦0.

For convenience, the indexset S={(a,h,i)|aεA,hεH,i=0, . . . , n_{a,h}−1} is introduced labeling the n_{a,h} interpolation points of a bid curve. If s=(a,h,i) is a composite index, the increment is defined by s+1=(a,h,i+1). For later purposes, the set of indices corresponding to constant successive prices, S^{↓}={sεS|pₛ=p_{S+1}}, is introduced as well as the subset corresponding to constant successive quantities, S^{→}={sεS|qₛ=qₛ₊₁}. The indexset S_{a,h}={(a,h,i)|i=0, . . . , n_{a,h}−1} labels the interpolation point indices for area a and hour h.

### II.2.4.2 Block Bids.

A block bid reflects the intention to buy or sell a certain quantity in a number of hours simultaneously on an all-or-nothing basis. For bookkeeping purposes, block bids are identified by a unique index. The set of all block bids in market aεA is labeled by the index-set Bₐ.

A block bid carries a price parameter p_{b}, the limit price. Additionally, the block bid defines a bid quantity parameter q_{b,h} for every delivery hour hεH. These bid quantity parameters should either be non-negative (buy block bid), or non-positive (sell block bid). Block bids with all bid quantity parameters equal to zero are disallowed.

### II.2.4.3 Block Links.

One block bid b (source) can be linked to another block bid c (destination) if b and c are both in the same market area. The link b [symbol] c places restrictions on the executability of the block bid b being the link source. The link relation is n-to-one; more block bids can be linked to one destination block bid. Chains of links are also allowed.

### II.2.4.4 Convertible Block Bids.

Convertible block bids are block bids that carry a reference to an additional bid curve, the so-called conversion curve. Buy blocks must reference to buy curves, sell blocks should reference to sell curves. The conversion curve must extend from the area minimum to the area maximum price. Under certain conditions, convertible block bids may be converted.

### II.2.4.4.1 Block Bid Conversion.

The conversion steps for a block bid b in area a are as follows.
(1) Remove the block bid from its market areas' block bid list, Bₐ←Bₐ\{b}.
(2) For every delivery hour with non-zero block bid quantity parameter, i.e. for all hεH with q_{b,h}≠0, the following step is performed.
(3) Accumulate the conversion curve ζ_{b} and the bid curve ζ_{a,h} of the hourly bid of the delivery hour into a new bid curve. Replace the bid curve of the hourly bid by the result of the accumulation ζ_{a,h}←ζ_{b}⊕ζ_{a,h}.

### II.2.4.5 Flexible Bids.

The index-set of all flexible bids belonging to a market area a is denoted by Fₐ. A flexible bid with index f carries a price parameter p_{f}—the limit price—and a quantity parameter q_{f}. Buy (sell) flexible bids should have a positive (negative) quantity parameter.

### II.2.5 Interconnectors

Interconnectors model physical power lines connecting two market areas. The set of interconnectors I⊂{a→b|a,bεA} should be regarded as directed links a→b that can transport quantity from one market area to another (flow). Interconnectors have certain additional properties.

### II.2.5.1 Available Transport Capacity Limits.

Available transport capacity (ATC) limits are quantity parameters that restrict the capacity of interconnectors. Per delivery hour, each interconnector has an ATC limit, i.e. for any a→bεI and hεH a capacity limit f_{a→b,h} is defined. ATC limits may be positive, zero or negative. Negative ATC limits enforce the negated ATC value as minimal flow in the opposite direction, positive ATC's put upper limits on the flow. Valid ATC limits have to satisfy the consistency condition—f_{b→a,h}≦f_{a→b,h}.

### II.2.5.2 Ramping Limits.

An interconnector a→b might be subject to ramping, in which case a positive, delivery hour independent ramping parameter r_{a,b} is defined. The ramping parameter limits the absolute flow change from one hour to another. Ramping parameters must be direction independent, r_{a,b}=r_{b,a}. For interconnectors not being subject to ramping, the parameter is formally set to infinity r_{a,b}→∞.

### II.2.5.3 Last Hour Flows.

Last hour flows are the flows on the inter-connector for the last delivery hour of the previous delivery day. The parameter is relevant only in case ramping limits are defined. For convenience the notation \hat{ρ}_{a→b,-1} is used for the last hour flow on interconnector a→b.

### II.2.5.4 Dead-Band Limits.

A cable might be subject to power loss measured by a dead-band parameter on the interconnector. The dead-band η_{a,b} is a dimensionless number between zero and one indicating the fraction of the exported quantity that gets delivered at the destination area of the flow. Dead-band should be direction independent, η_{a,b}=η_{b,a}.

### II.3 Market Coupling

Market coupling is performed by an implicit auction. After executing the auction calculation, an auction result is obtained. It is a particular feature of the market model defined here in this specific embodiment that rules define the desired properties of the result (with the exception of block bid conversion), and not a procedure describing how to obtain the result.

In the model described in this specific embodiment, the auction calculation involves solving a series of constraint optimization problems. A set of the market rules define the constraints on these optimization sub-problems. Additional rules determine a hierarchy of objectives that should be optimized.

### II.3.1 Market Model Variables

### II.3.1.1 Coupling Variables

### II.3.1.1.1 Prices.

As variables, the prices pₐ⁻≦π_{a,h}≦pₐ⁺ are introduced for the market areas aεA and delivery hours hεH. The calculated value of the price variable is called clearing price.

### II.3.1.1.2 Flows.

The directed flow quantity on interconnector a→b is denoted by non-negative variable ρ_{a→b,h}≦0. The undirected or net flow variable is defined by ρ̅_{a→b,h}=ρ_{a→b,h}−ρ_{b→a,h}. Trivially, the net flow is antisymmetric with respect to flow direction change, ρ̅_{a→b,h}=− ρ̅_{b→a,h} and ρ̅_{a→a,h}=0.

### II.3.1.1.3 Exported and Imported Quantities.

The quantity export and import variables φ_{a→b} and φ_{a←b} of an area aεA from or into any other area bεA model the quantity contribution of flow to the area's total buy and sell balances. Quantity export φ_{a→b} from a is handled like a non-negative buy bid quantity. Imported quantity φ_{a←b} corresponds to a non-positive sell bid quantity.

### II.3.1.2 Bid Quantities

### II.3.1.2.1 Hourly Bids.

For hourly bids, the hourly bid buy φ_{a,h,B} is introduced and sell quantities φ_{a,h,S} per area aεA and hour hεH. They are bound by φ_{a,h,B}⁺≧φ_{a,h,B}≧φ_{a,h,B}⁻ for buy and by φ_{a,h,S}⁺≧φ_{a,h,S}≧φ_{a,h,S}⁻ for sell quantities. Accounting for the bid curve model, these bounds are given by q_{a,h,{B,S}}⁻=φ_{a,h,{B,S}}⁻ and q_{a,h,{B,S}}⁺=φ_{a,h,{B,S}}⁺.

### II.3.1.2.2 Block Bids.

For block bids, a variable 0≦β_{b}≦1 per index bεB is introduced indicating its execution status. A block is called not executed if β_{b}=0, partially executed if 0<β_{b}<1, and fully executed if β_{b}=1. The block bid's executed quantity variable in hour hεH is defined to be equal to the bid's quantity parameter in that respective hour times the execution variable, φ_{b,h}=β_{b}q_{b,h}.

### II.3.1.2.3 Flexible Bids.

Similar to block bids, an execution variable 0≦β_{f,h}≦1 per flexible bid fεF and hour hεH is introduced. A flexible bid is called not executed in hour h if β_{f,h}=0, partially executed if 0<β_{f,h}<1, and fully executed if β_{f,h}=1. The flexible bid executed quantity variable is defined as the product of execution variable and its quantity parameter, φ_{f,h}=β_{f,h}q_{f,h}.

### II.3.2 Market Coupling Result Data

The auction calculation fixes the model variables. An overview of the output quantities in scope is given in Table 2. By convention, the calculated value of variable x is marked by \hat{x}. Depending on the variant of the market model in scope, the calculation result must satisfy a subset of the market rules stated below.

### II.4 Market Rules

In what follows market rules of the specific embodiment are enumerated. For each rule, a verbal description is given, followed by a mathematical condition. Rules are tagged by a label [ [symbol] Group [symbol] : [symbol] Rule [symbol] ] at the beginning of the definition, and ended by a rule symbol ▪. The formalized description is typically structured as follows.

∀ Indexset:

Preconditions

[symbol] Requirements

### II.4.1 Bid Rules

Bid rules apply to bids within a market area.

### II.4.1.1 Hourly Bids

### II.4.1.1.1 Full Execution

[HY:FUL] If the market area's clearing price is strictly within the price limits of the area, then hourly bids are always executed completely at the clearing price. In other words, the clearing price and the hourly executed quantity is a point on the respective bid curve. The execution price of the hourly bid is the clearing price. This holds for both, hourly buy and sell bids.

∀aεA, hεH:

pₐ⁻<\hat{π}_{a,h}<pₐ⁺

[symbol]

(\hat{π}_{a,h}|\hat{φ}_{a,h,B})εζ_{a,h,B}̂(\hat{π}_{a,h}|\hat{φ}_{a,h,S})εζ_{a,h,S}

▪

### II.4.1.2 Block Bids

### II.4.1.2.1 All-or-Nothing

[BK:AON] A block bid can only be executed all-or-nothing. The executed quantity in each hour is equal to the quantity parameter of the block bid in that hour, or zero in all hours.

∀bεB,hεH:

[symbol]

\hat{φ}_{b,h}=\hat{β}_{b}q_{b,h}̂\hat{β}_{b}ε{0,1}

▪

### II.4.1.2.2 Partial Execution

For later purposes, a relaxation rule is defined which permits partial execution of block bids.

[BK:AON′] The execution variable of a block bid is in the range of [0, 1]. The executed block bid quantity per hour is equal to the quantity parameter times the execution parameter of the block bid.

∀bεB,hεH:

[symbol]

\hat{φ}_{b,h}=\hat{β}_{b}q_{b,h}̂0≦\hat{β}_{b}≦1

### II.4.1.2.3 In-the-Money

By definition, the execution price variable of a block bid bεBₐ is the average market price per hour weighted with the block-bid quantities for that hour.

$${π}_{b} = \frac{{\sum }_{h ∈ H}^{ } {π}_{a , h} {q}_{b , h}}{{\sum }_{h ∈ H}^{ } {q}_{b , h}} \qquad ( 4.1 .1 )$$

[BK:ITM] Partially or fully executed block bids must not be out of the money with respect to their execution price. Buy block bids have an execution price not higher than the bid's limit price, sell block bids must have an execution price not lower than its limit price.

$$∀ a ∈ A , b ∈ {B}_{a} \text{:} {\hat{β}}_{b} > 0 ⇒ {\hat{π}}_{b} {\sum }_{h ∈ H}^{ } {q}_{b , h} = {\sum }_{h ∈ H}^{ } {\hat{π}}_{a , h} {q}_{b , h} \leq {p}_{b} {\sum }_{h ∈ H}^{ } {q}_{b , h}$$

▪
Note: The multiplication by the total quantity allows to formulate a common rule for buy and sell block bids.

### II.4.1.2.4 Block Links

[BK:LNK] Suppose a source block bid is linked to destination block bid. A precondition for the source block bid to be executed is the execution of the destination block bid.

∀a [symbol] bεL:

\hat{β}ₐ=1

[symbol]

\hat{β}_{b}=1

▪

### II.4.1.3 Flexible Bids

### II.4.1.3.1 All-or-Nothing

[FX:AON] The flexible bid quantity must be executed completely in exactly one hour, or not at all.

If the flexible bid is executed, its execution quantity is equal to the flexible bid quantity parameter.

$$∀ f ∈ F , h ∈ H \text{:} ⇒ {\hat{ϕ}}_{f , h} = {\hat{β}}_{f , h} {q}_{f} {\hat{β}}_{f , h} ∈ \{ 0 , 1 \} 0 \leq {\sum }_{{h}^{′} ∈ H}^{ } {\hat{β}}_{f , {h}^{′}} \leq 1$$

▪

### II.4.1.3.2 Partial Execution

For the intermediate model, a relaxation of the All-Or-Nothing condition is defined.

[FX:AON′] The executed quantity of a flexible bid per hour is its execution variable times the bid's quantity parameter. The sum of the execution parameters over all hours is in the range [0, 1].

$$∀ f ∈ F , h ∈ H \text{:} ⇒ {\hat{ϕ}}_{f , h} = {\hat{β}}_{f , h} {q}_{f} 0 \leq {\hat{β}}_{f , h} \leq 1 0 \leq {\sum }_{{h}^{′} ∈ H}^{ } {\hat{β}}_{f , {h}^{′}} \leq 1$$

▪

### II.4.1.3.3 In-the-Money

[FX:ITM] The execution price π_{f} of flexible bids is the market clearing price of the area and hour the flexible bid is executed. Partially or fully executed flexible bids must not be out of the money in the hour they are executed.

∀aεA,hεH,fεFₐ: β_{f,h}>0

[symbol]

▪

### II.4.2 Interconnector Constraints

### II.4.2.1 Flow Constraints

### II.4.2.1.1 ATC Limits

[FW:ATC] If the ATC limit is non-negative, the calculated directed flow is limited from above by the ATC limit of that direction and limited from below by the negative ATC limit in the opposite direction. Conversely, if the ATC limit in a direction is negative the calculated directed flow in that direction is zero.

### Non-Negative ATC Limit

∀a→bεI,hεH:

f_{a→b,h}≧0

[symbol]

−f_{b→a,h}F≦\hat{ρ}_{a→b,h}≦f_{a→b,h}

### Negative ATC Limit

∀a→bεI,hεH:

f_{a→b,h}<0

[symbol]

\hat{ρ}_{a→b,h}=0

▪

Note: The second rule must be introduced to avoid a conflict with the non-negativity of directed flows. These ATC rules can be combined with the condition ρ_{a→b,h}≧0 into effective limits for the directed flows by

f_{a→b,h}⁻≦ρ_{a→b,h}≦f_{a→b,h}⁺ (4.2.1)

with

f_{a→b,h}⁻=Max(0,−f_{b→a,h})f_{a→b,h}⁺=Max(0,f_{a→b,h}) (4.2.2)

For convenience, the effective conditions are used in the formulation of the market models. By definition, if the directed flow ρ_{a→b,h} is at upper (lower) bound of the effective limit, there is ATC-congestion from above (below) in direction a→b in hour h.

### II.4.2.1.2 Ramping

[FW:RMP] The net flow may not change more than the ramping limit for consecutive delivery hours, including the last hour of the previous delivery day.

∀a→bεI,hεH:

[symbol]

| \overline{\hat{p}}_{a→b,h}− \overline{\hat{ρ}}_{a→b,h-1}|≦r_{a,b}

▪
Note: It is sufficient to require

\overline{\hat{ρ}}_{a→b,h}− \overline{\hat{ρ}}_{a→b,h-1}≦r_{a,b}. (4.2.3)

Since this weaker condition must apply to all area combinations, it may be rewritten by swapping the indices a and b, \overline{\hat{ρ}}_{b→a,h}− \overline{\hat{ρ}}_{b→a,h-1}≦r_{b,a}. Taking into account the antisymmetry of the net flow with respect to direction change, and the symmetry property of the ramping constants r_{a,b}=r_{b,a}, one gets − \overline{\hat{ρ}}_{a→b,h}+ \overline{\hat{ρ}}_{a→b,h-1}≦r_{a,b} which corresponds to the second condition implied by the absolute value in the rule. Additionally, this condition can also be interpreted as lower bound to the flow change, −r_{a,b}≦ \overline{\hat{ρ}}_{a→b,h}− \overline{\hat{ρ}}_{a→b,h-1}.

### II.4.2.1.3 Deadband

[FW:DBN] If there is flow from area a to b, then the corresponding quantity export from a in direction b equals the directed flow along a→b. The imported quantity from a into b is the negative directed flow along a→b times the deadband parameter η_{a,b}.

∀a→bεI,hεH:

[symbol]

\hat{φ}_{a>b,h}=\hat{ρ}_{a→b,h}̂\hat{φ}_{b←a,h}=−η_{a,b}\hat{ρ}_{_{a→b,h}}

▪

### II.4.2.2 Flow-Price Conditions

As discussed in the note, combine lower and upper flow bounds resulting from the rule [FW:RMP] for consecutive hours

\hat{ρ}_{a→b,h}⁺:=min( \overline{\hat{ρ}}_{a→b,h-1}+r_{a,b}, \overline{\hat{ρ}}_{a→b,h+1}+r_{a,b}) (4.2.4)

\hat{ρ}_{a→b,h}⁻:=max( \overline{\hat{ρ}}_{a→b,h-1}−r_{a,b}, \overline{\hat{ρ}}_{a→b,h+1}−r_{a,b}) (4.2.5)

with the net flow restricted to the range

\hat{ρ}_{a→b,h}⁻≦ \overline{\hat{ρ}}_{a→b,h}≦\hat{ρ}_{a→b,h}⁺. (4.2.6)

By definition, if the net flow ρ̅_{a→b,h} is at the upper (lower) bound of the limits eqs. (4.2.4) and (4.2.5), there is ramping-congestion from above (below) in direction a→b in hour h.

### II.4.2.2.1 Uncongested Flow and Prices

[FP:UCG] Suppose there is non-negative net flow from an exporting to an importing market area. If there is no congestion from above (below) in that direction, i.e. if neither the directed flow is at the upper (lower) ATC limit nor the net flow at the upper (lower) bound of the ramping rule, and the clearing prices in the adjacent areas are not at their area price limits, then the clearing price in the exporting area should be larger (smaller) or equal to the price in the importing area times the dead-band factor.

Uncongested from above.

∀a→bεI,hεH:

pₐ⁻<\hat{π}_{a,h}<pₐ⁺̂p_{b}⁻<\hat{π}_{b,h}<pₐ⁺̂

\overline{\hat{ρ}}_{a→b,h}<\hat{ρ}_{a→b,h}⁺̂\hat{ρ}_{a→b,h}<f_{a→b,h}⁺

[symbol]

\hat{π}_{a,h}≧η_{a,b}\hat{π}_{b,h}

Uncongested from below.

∀a→bεI,hεH:

pₐ⁻<\hat{π}_{a,h}<pₐ⁺̂p_{b}⁻<\hat{π}_{b,h}<pₐ⁺̂

\hat{ρ}_{a→b,h}⁻< \overline{\hat{ρ}}_{a→b,h}⁺̂f_{a→b,h}⁻<\hat{ρ}_{a→b,h}

[symbol]

π_{a,h}≦η_{a,b}π_{b,h}

▪

### II.4.3 Curtailment Rules

Curtailment buy and sell emerges in market situations where supply and demand cannot be balanced locally by hourly bids, block or flexible bids, or globally by flow import or export. That can only appear if the clearing price is at the area's minimum or maximum value. In such cases market rules allow under certain conditions that the offered hourly quantity is executed only partially. Incomplete execution is described by the factors

γ_{a,h,S}=\hat{φ}_{a,h,S}/φ_{A,h,S}⁺ (4.3.1)

and

γ_{a,h,B}=\hat{φ}_{a,h,B}/φ_{a,h,B}⁻ (4.3.2)

where factors γ_{a,h,S}<1 and γ_{a,h,B}<1 indicate curtailment. In general, market rules aim at avoiding curtailment whenever possible.

### II.4.3.1 Area Curtailment Rules

Area curtailment rules are rules that apply within one area when the hourly buy or sell bids are not sufficient to balance demand and supply locally.

### II.4.3.1.1 Curtailment of Hourly Bids

[CA:HLY] If the market area's clearing price is at the area's minimum (maximum) in an hour, the hourly sell (buy) bid may be executed partially. In particular, the executed sell (buy) quantity can zero or between zero and the maximum (minimum) quantity of the sell (buy) curve. The hourly buy (sell) bid must be executed completely at the minimum (maximum) price.

Curtailment sell.

∀aεA,hεH:

\hat{π}_{a,h}=pₐ⁻

[symbol]

φ_{a,h,S}⁺<\hat{φ}_{a,h,S}≦0

Curtailment buy.

∀aεA,hεH:

\hat{π}_{a,h}=pₐ⁺

[symbol]

0≦\hat{φ}_{a,h,B}<φ_{a,h,B}⁻

▪

### II.4.3.1.2 No Block Bids in Curtailment

In curtailment situations, block bids may degrade curtailment. One rule to avoid this is to forbid the execution of block bids that have non-zero quantity in the respective hour.

[CA:NBK] If there is curtailment sell (buy) in a particular hour, no sell (buy) block bids with a non-zero quantity parameter in that hour should be executed.

Curtailment Sell.

∀aεA,bεBₐ,hεH:

\hat{φ}_{a,h,S}>φ_{a,h,S}⁺̂q_{b,h}<0

[symbol]

\hat{β}_{b}=0

Curtailment Buy.

∀aεA,bεBₐ,hεH:

\hat{φ}_{a,h,B}<φ_{a,h,B}⁻̂q_{b,h}>0

[symbol]

\hat{β}_{b}=0

▪

### II.4.3.1.3 Block Bid Conversion

[CA:CNV] If in some hour there is curtailment buy or curtailment sell, then all convertible block bids which have non-zero quantity parameter in that hour should be converted.

∀aεA,bεBₐ,hεH:

(\hat{φ}_{a,h,S}>φ_{a,h,S}⁺ [symbol] \hat{φ}_{a,h,B}<φ_{a,h,B}⁻) [symbol] q_{b,h}≠0

[symbol]

ζ_{a,h}←ζ_{b}⊕ζ_{a,h} [symbol] B←B\{b}

▪

### II.4.3.1.4 Intrinsic Curtailment

The intrinsic curtailment of a market area is the curtailment buy or sell one obtains if one takes into account only the hourly buy and sell bids of that area, without any flow import or export, and without block or flexible bids. Three cases can be separated.

Intrinsic Curtailment Sell
The maximum quantity of the buy curve is smaller than the absolute value of the maximum of the sell curve, φ_{a,h,B}⁺<|φ_{a,h,S}⁺|. The intrinsic curtailment factor sell is γ̅_{a,h,S}=φ_{a,h,B}⁺/|φ_{a,h,S}⁺|.

Intrinsic Curtailment Buy
The minimum quantity of the buy curve is larger than the absolute value of the minimum of the sell curve, φ_{a,h,B}⁻>|φ_{a,h,S}⁻|. The intrinsic curtailment factor buy is γ̅_{a,h,B}=|φ_{a,h,S}⁻|/φ_{a,h,B}⁻.

No Intrinsic Curtailment
The sum of the hourly buy and sell curve has a root between or at the price limits of the market area. This is the case if both φ_{a,h,B}⁺+φ_{a,h,S}⁺≧0 and φ_{a,h,B}⁻+φ_{a,h,S}⁻≦0.

### II.4.3.1.5 Non-Degradation Of Curtailment

[CA:NDG] Curtailment sell (buy) in an area should not exceed intrinsic curtailment.

Curtailment Sell.

∀aεA,hεH:

\hat{π}_{a,h}=pₐ⁻

[symbol]

\hat{φ}_{a,h,S}≦max(φ_{a,h,S}⁺,−φ_{a,h,B}⁺)

Curtailment Buy.

∀aεA,hεH:

\hat{π}_{a,h}=pₐ⁺

[symbol]

\hat{φ}_{a,h,B}≧min(φ_{a,h,B}⁻,−φ_{a,h,S}⁻)

### II.4.3.2 Bilateral Curtailment Rules

Bilateral curtailment rules address the influence of neighbouring areas on curtailment sell or buy.

### II.4.3.2.1 No Im- or Export for Curtailment

[CB:NIE] If there is curtailment sell (buy) in one area, there should not be imported (exported) quantity from any neighbouring area.

Curtailment Sell.

∀a←bεI,hεH:

\hat{φ}_{a,h,S}>φ_{a,h,S}⁺

[symbol]

\hat{φ}_{a←b,h}=0

Curtailment Buy.

∀a→bεI,hεH:

\hat{φ}_{a,h,B}<φ_{a,h,B}⁻

[symbol]

\hat{φ}_{a→b,h}=0

▪

### II.4.3.2.2 Spreading Of Curtailment

[CB:SPD] Spreading of curtailment applies to connected market areas which have equal clearing prices equal to their common area's minimum (maximum) price limits. The sell (buy) curves in the neighbouring areas should experience the same relative curtailment sell (buy), i.e have the same curtailment factor.

Curtailment Sell.

∀a,bεA,hεH:

\hat{π}_{a,h}=\hat{π}_{b,h}=pₐ⁻=p_{b}⁻

[symbol]

γ_{a,h,S}=γ_{b,h,S} or \hat{φ}_{a,h,S}φ_{b,h,S}⁺=\hat{φ}_{a,h,S}⁺

Curtailment Buy.

∀a,bεA,hεH:

\hat{π}_{a,h}=\hat{π}_{b,h}=pₐ⁺=p_{b}⁺

[symbol]

γ_{a,h,B}=γ_{b,h,B} or \hat{φ}_{a,h,B}φ_{b,h,B}⁻=\hat{φ}_{a,h,B}⁻

▪

### II.4.4 Coupling Rules

### II.4.4.1 Balance

It is a fundamental property of every auction result that overall demand and supply quantities must balance.

### II.4.4.1.1 Area Balance

[BC:ARA] For each market area and each hour, the sum (non-zero buy quantities are counted positive, non-zero sell quantities are counted negative) of the executed quantities of hourly, block and flexible bids plus the exported and imported quantities must be zero.

$$∀ a ∈ A , h ∈ H \text{:} ⇒ {\hat{ϕ}}_{f , h , B} + {\hat{ϕ}}_{a , h , s} + {\sum }_{b ∈ {B}_{a}}^{ } {\hat{ϕ}}_{b , h} + {\sum }_{b ∈ {F}_{a}}^{ } {\hat{ϕ}}_{f , h} + {\sum }_{b ∈ A}^{ } ( {\hat{ϕ}}_{a \to b , h} + {\hat{ϕ}}_{a ← b , h} ) = 0$$

▪

### II.4.5 Optimization Goals

### II.4.5.1 Socio-Economic Welfare

### II.4.5.1.1 Hourly Bids

The contribution to the socio-economic welfare of an hourly bid at a given price 7 is the area between the price-axes and the bid curve, starting at the price and extending to the area's maximal price (some authors take positive quantities for sell curves. Then the socio-economic welfare contribution is the integral from the area's minimum price extending to the price. This definition differs from the one given here only by a constant term which can be disregard for the optimization rule)

$${ω}_{a , h , \{ B , S \}} = {\int }_{{π}_{a , h}}^{{p}_{a}^{+}} d {ζ}_{a , h , \{ B , S \}} . \qquad ( 4.5 .1 )$$

The mathematical definition of the integral is given in eq. (A.3.1)

### II.4.5.1.2 Block Bids

Executed block bids bεBₐ contribute

$${ω}_{b} = {β}_{b} {\sum }_{h ∈ H}^{ } {q}_{b , h ( {p}_{b} - {π}_{a , h} )} \qquad ( 4.5 .2 )$$

to the socio-economic welfare.

### II.4.5.1.3 Flexible Bids

Executed flexible bids fεFₐ contribute only in the hour they are executed to the socio-economic welfare

ω_{f,h}=β_{f,h}q_{f}(p_{f}−π_{a,h}) (4.5.3)

### II.4.5.1.4 Flows

A flow of ρ_{a→b} on an interconnector a→b exports some quantity φ_{a→b}=p_{a→b}, and imports the dead-band reduced quantity φ_{b←a}=−η_{a,b}ρ_{a→b} into area b. This is equivalent to buying the quantity at the price of area a and selling the reduced quantity at the price of b. Consequently, the contribution to the socio-economic welfare—the congestion rent—is given by

ω_{a→b,h}=−π_{a,h}φ_{a→b}−π_{b,h}φ_{b←a}. (4.5.4)

### II.4.5.1.5 Maximization of Socio-Economic Welfare

[OT:WLF] The model variables should maximize the overall socio-economic welfare of hourly bids, block bids, flexible bids and congestion rent.

$$⇒ {\sum }_{{a ∈ A}_{{h ∈ H}_{z ∈ [ B , S ]}}}^{ } {ω}_{a , h , z} + {\sum }_{b ∈ B}^{ } {ω}_{b} + {\sum }_{{f ∈ F}_{h ∈ H}}^{ } {ω}_{f , h} + {\sum }_{{a \to b ∈ I}_{h ∈ H}}^{ } {ω}_{a \to b , h} \to Max$$

▪

### II.4.5.2 Flow Rules

In general, the maximization of the socio-economic welfare does not lead to a unique solution. In particular, circular flows—if allowed by flow constraints—do not alter the value of the socio-economic welfare objective value since the net quantity flow into a market area, import minus export, remains unchanged. These circular flows should be avoided. Particularly, there should never be both, flow a→b and flow b→a. At least one of \hat{ρ}_{a→b,h} or \hat{ρ}_{b→a,h} should be zero. Two proposals have been made to fix flow ambiguities.

### II.4.5.2.1 Linear Flow Minimization

[OT:FLN] The sum of the flows should be minimal.

$$⇒ {\sum }_{{a \to b ∈ I}_{h ∈ H}}^{ } {\hat{ρ}}_{a \to b , h} \to Min$$

▪

Note: Linear optimization does not necessarily lead to a unique solution. For example, routing flow along a→b→c or routing it along an alternative path with equal length a→b′→c contributes the same quantity to the linear objective function.

### II.4.5.2.2 Quadratic Flow Minimization

[OT:FQU] The sum of the squares of the flows should be minimal.

$$⇒ {\sum }_{{a \to b ∈ I}_{h ∈ H}}^{ } {\hat{ρ}}_{a \to b , h}^{2} \to Min$$

▪

### II.4.5.3 Price Rules

Even after the step of flow minimization, price ambiguities may arise. That may happen if the calculated price on the buy and the sell bid curves is between two interpolating points with equal quantity. Then, a price range is associated with one hourly quantity. In that case the socio-economic welfare and flow export/import are the same for any price within that range. To define unique solutions, an additional rule has to be imposed.

### II.4.5.3.1 Linear Minimum Price Rule

[OT:PMN] If there are price ambiguities, the minimum possible price should be chosen.

∀aεA,hεH:

[symbol]

\hat{π}_{a,h}→Min

▪

### II.4.5.3.2 Quadratic Minimum Price Rule

This rule requires some preparative definitions. The net bid curve is defined as ζ_{a,h}=ζ_{a,h,B}⊕ζ_{a,h,S}. Now suppose (pᵢ,qᵢ),(pᵢ₊₁,qᵢ₊₁)εζ_{a,h} are two successive interpolating points on the net bid curve enclosing the calculated clearing price such that pᵢ≦\hat{π}_{a,h}≦pᵢ₊₁. The permissible price range is given by

$$[ {\hat{π}}_{a , h}^{-} , {\hat{π}}_{a , h}^{+} ] = \{ \begin{matrix}[ {p}_{i} , {p}_{i + 1} ] & if & {q}_{i} = {q}_{i + 1} \\ [ {\hat{π}}_{a , h} , {\hat{π}}_{a , h} ] & if & {q}_{i} > {q}_{i + 1}\end{matrix} \qquad ( 4.5 .5 )$$

[OT:PMD] If there are price ambiguities, the price with the least quadratic deviation from the mid-price of the corresponding permissible price range should be chosen.

∀aεA,hεH:

[symbol]

(2\hat{π}_{a,h}−\hat{π}_{a,h}⁺−\hat{π}_{a,h}⁻)²→Min

▪

### II.4.5.4 Volume Rules

In case of remaining executed quantity indeterminacies, volume rules have to be defined to uniquely fix the hourly executed quantities at the buy and sell sides separately.

### II.4.5.4.1 Maximization of Executed Volume

[OT:VMX] In case there are quantity indeterminacies, the total executed hourly volume should be maximized.

∀aεA,hεH:

[symbol]

\hat{φ}_{a,h,B}−\hat{φ}_{a,h,S}→Max

▪

### II.5 Market Model

The rules defined in II.4 form basic building blocks for market models.

### II.5.1 Rule Consistency

Not any combination of rules can form a consistent market model since rules may imply conflicting conditions. Considering two rules A and B, different rule relations can be observed.
A [symbol] B: Rule A is stricter than rule B. Both rules can be applied simultaneously, but the result is the same as if one applies rule A only.
A⊥B: Rule A strictly contradicts rule B. If both rules are applied simultaneously, then the market model does not permit for a solution.

Rule conflicts may also appear only for particular market input data. Accordingly, intrinsic and data incompatibilities are distinguished.

### II.5.1.1 Intrinsic Rule Incompatibilities

Intrinsic incompatibilities arise when rules describe conflicting objectives.
[CA:NBK] [symbol] [CA:NDG]: In the case of curtailment, removing all block bids in the curtailed hours is stricter than just removing those blocks that degrade curtailment. In the latter case, buy and sell block quantities may compensate without degrading curtailment of the hourly bids.
[CB:NIE] [symbol] [CA:NDG]: In case of curtailment, setting the import into or export from curtailed areas to zero is the stricter requirement. In fact, in the case of rule [CA:NDG], the degradation of curtailment caused by im- or export can be compensated by quantity of block or flexible bids.
[CB:NIE]⊥[CB:SPD]: In case of curtailment, setting the im- or export to zero renders it impossible to spread curtailment by adjusting the flow.
[OT:FLN]⊥[OT:FQU]: Linear and quadratic flow minimization in general leads to different results.
[OT:PMN]⊥[OT:PMD]: These price rules have different objectives.

### II.5.1.2 Data Incompatibilities

Data incompatibilities between rules may arise if some of the market model input data are conflicting. In general, data incompatibility leads to an infeasible problem and the market data do not allow to find a solution.
[FW:ATC]⊥[FW:RMP]: This incompatibility appears when the upper (lower) flow limit of one hour and the lower (upper) flow limit of the successive hour differ by more than the ramping parameter. In particular, also the last hour flow and the lower (upper) flow limit of the first hour must be within the given ramping constraint.
[BC:ARA]⊥[FW:ATC]: This incompatibility comes up when a forced minimal or maximal flow cannot be balanced by the market area's hourly quantity.

### II.5.2 Hybrid Model

A market model is defined by a subset of the market rules defined in II.4. Successfully solving a model implies to find a binding of the model variables such that all model specific rules are satisfied.

### II.5.2.1 Definition

The Hybrid Model is the effective top level market model and is a specific implementation of the first model 210. It is flexible in the sense that some rules can configured to be in effect on an interconnector or market area level. In particular, a subset of the given curtailment rules is defined specifically per area and interconnector.

The Hybrid Model is not a set of rules together with a single optimization goal, but includes a hierarchy of submodels with individual optimization goals which are to be solved one after another.

### II.5.2.2 Ruleset

The model implements the following rules.
(1) Hourly Bids
   (a) Full execution [HY:FUL]
      or Curtailment Of Hourly Bids [CA:HLY].
(2) Block Bids
   (a) All-Or-Nothing [BK:AON].
   (b) In-The-Money [BK:ITM].
   (c) Block Links [BK:LNK].
(3) Flexible Bids
   (a) All-Or-Nothing [FX:AON].
   (b) In-The-Money [FX:ITM].
(4) Flows Constraints
   (a) ATC Limits [FW:ATC].
   (b) Ramping [FW:ATC].
   (c) Deadband [FW:DBN].
(5) Quantity Balance [BC:ARA]
(6) Flow-Price Conditions.
   (a) Uncongested Flow And Prices [FP:UCG].
(7) Area Curtailment Rules (Configurable per area).
   (a) Optional: Block Bid Conversion [CA:CNV].
   (b) Optional: No Block Bids in Curtailment [CA:NBK]
      or Non-Degradation Of Curtailment [CA:NDG].
(8) Bilateral Curtailment Rules (Configurable per interconnector)
   (a) Optional: No Im- Or Export for Curtailment [CB:NIE]
      or Spreading Of Curtailment [CB:SPD].
(9) Socio-Economic Welfare Maximization.
   These rules are applied hierarchically. Particularly first the rule is fixed while the rule with the lower priority is applied.
   (a) Maximization Of Socio-Economic Welfare [OT:WLF].
   (b) Linear Flow Minimization [OT:FLN]
   or Quadratic Flow Minimization [OT:FLN].
   (c) Linear Minimum Price Rule [OT:PMN]
   or Quadratic Minimum Price Rule [OT:PMD].
   (d) Maximisation Of Executed Volume [OT:VMX].

Referring to FIG. 2, Rules (9)(b) to (9)(d) are a specific implementation of the third subset of rules 225. The conditions All-Or-Nothing [BK:AON] for block bids and [FX:AON] for flexible bids, the area curtailment rules [CA:CNV] and [CA:NBK], the bilateral curtailment rules [CB:NIE] and [CB:SPD], and the block link conditions [BK:LNK], the flow-price condition [FP:UCG], the in-the-money conditions [BK:ITM] and [FX:ITM], and the full execution condition for hourly bids [HY:FUL] are a specific implementation of the first subset of rules 215.

### II.5.2.3 Hierarchical Decomposition

In order to find solutions for the Hybrid Model, the problem is decomposed into subproblems.
(1) Socio-Economic Welfare Optimisation.
   In that step the Welfare Model is solved. The solution strategy involves the solution of the Continuous Model which in turn is solved by evaluating solutions of the Relaxation Model.
(2) Flow determination. Flow determination is performed by solving the Flow Model.
(3) Price determination. Price determination is performed by solving the Price Model.
(4) Volume determination. Finally, volume determination is performed by maximizing hourly volume in the Volume Model.

An overview of the submodels and their relations is given in FIG. 4. The models are defined in detail in section II.5.3.

### II.5.3 Submodels

### II.5.3.1 Welfare Model

The central entry point into socio-economic welfare optimization is the Welfare Model 510. This is a model with linear, conditional and integer constraints and quadratic objective.

### II.5.3.1.1 Definition

As far as rules are concerned, the Welfare Model 510 is identical with the Hybrid Model, except that the only optimization goal is the maximization of socio-economic welfare defined in [OT:WLF]. The optimization strategy is to relax rules in a two-staged approach.

### II.5.3.2 Continuous Model

In the first stage all rules are relaxed which restrict variables to discrete value, and a subset of conditional curtailment rules. That reduces the complexity of the Welfare Model 510 from NP-complete to polynomial complexity.

### II.5.3.2.1 Definition

Still referring to FIG. 4, the Continuous Model 520 emerges from the quadratic socio-economic welfare optimization of the Welfare Model by dropping all integer constraints and some conditional rules.

In particular, it is obtained by relaxing at step S2 the conditions All-Or-Nothing [BK:AON] from block 515 into [BK:AON′] for block bids and [FX:AON] into [FX:AON′] for flexible bids. Additionally, the area curtailment rules [CA:CNV] and [CA:NBK], the bilateral curtailment rules [CB:NIE] and [CB:SPD], and the block link conditions [BK:LNK] from block 515 are relaxed.

### II.5.3.2.2 Ruleset

To summarize, the model respects the following rules.
(1) Hourly Bids
   (a) Full execution [HY:FUL]
      or Curtailment Of Hourly Bids [CA:HLY].
   (b) Non-Degradation Of Curtailment [CA:NDG].
(2) Block Bids
   (a) Partial execution [BK:AON′].
   (b) In-The-Money [BK:ITM].
(3) Flexible Bids
   (a) Partial execution [FX:AON′].
   (b) In-The-Money [FX:ITM].
(4) Flows Constraints
   (a) ATC limits [FW:ATC].
   (b) Ramping [FW:RMP].
   (c) Deadband [FW:DBN].
(5) Quantity Balance [BC:ARA].
(6) Flow-Price Conditions
   (a) Uncongested Flow And Prices [FP:UCG].
(7) Optimization Goals.
   (a) Socio-Economic Welfare Maximization [OT:WLF].

If a solution of the Continuous Model 520 violates some of the relaxed rules of the Welfare Model 510, the missing conditions have to be reintroduced by enforcing corresponding additional constraints. This is implemented in a Multibranch Algorithm discussed in detail in section II.7.1.3.

### II.5.3.3 Relaxation Model

### II.5.3.3.1 Definition

The solution of the Continuous Model 520 again is guided by further relaxation steps S3. Here, the flow-price condition [FP:UCG], the in-the-money conditions [BK:ITM] and [FX:ITM], and the full execution condition for hourly bids [HY:FUL] summarized in block 525 are relaxed at step S3. The curtailment rules [CA:HLY] and [CA:NDG] are implemented by an extension of the hourly bid curves (see section II.7.1.2.1). The Relaxation Model 530 is a specific implementation of the second model 230.

### II.5.3.3.2 Ruleset

(1) Hourly Bids
   (a) Full execution [HY:FUL] on the extended bid curves.
(2) Block Bids
   (a) Partial execution [BK:AON′]
(3) Flexible Bids
   (a) Partial execution [FX:AON′]
(4) Flows Constraints
   (a) ATC limits [FW:ATC]
   (b) Ramping [FW:RMP]
   (c) Deadband [FW:DBN]
(5) Quantity Balance [BC:ARA]
(6) Optimization Goals.
   (a) Socio-Economic Welfare Maximization [OT:WLF]

Luckily, one can show that optimal solutions of the Relaxation Model automatically fulfill the relaxed conditions, and represent equivalent optimal solutions of the Continuous Model 520. This fact is proved by Proposition II.6.4. The relaxation model is a specific implementation of the first model 230. The rules relaxed in steps S2 and S3 are a specific implementation of the set of relaxed rules 235.

### II.5.3.4 Flow Model

### II.5.3.4.1 Definition

A solution of the Welfare Model 510 does not necessarily have unique flows. To fix these ambiguities, the hourly, block and flexible bid quantities are fixed to the values obtained from the solution of the Welfare Model 510. Additionally, the socio-economic welfare is fixed to the optimal value. The flows are varied to optimize [OT:FLN] or [OT:FQU]. Note that on account of the balance condition, the net import and export into a market area also remains fixed in the flow optimization. The rules of the Flow Model 540 are specific implementations of rules of the third subset of rules 235.

### II.5.3.4.2 Ruleset

The Flow Model 540 respects the following rules.
(1) Flows Constraints
   (a) ATC Limits [FW:ATC]
   (b) Ramping [FW:RMP]
   (c) Deadband [FW:DBN]
(2) Quantity Balance [BC:ARA]
(3) Optimization Goals
   (a) Linear Flow Minimization [OT:FLN]
      or Quadratic Flow Minimization [OT:FQU].

### II.5.3.5 Price Model

### II.5.3.5.1 Definition

Even after determination of flows, the optimal solution is not necessarily unique. This may appear if the calculated executed hourly quantity corresponds to a price discontinuity i.e. when the hourly quantity does not correspond to a unique price but a price range.

In that case, from the solution of the Flow Model 540, the flow-price conditions are determined and the prices are constraint to those price ranges which are compatible with the determined hourly executed quantities. Additionally, included block and flexible bids need to remain in the money. The prices are optimizes according to the price rules [OT:PMN] and [OT:PMD].

The rules of the Price Model 550 are specific implementations of rules of the third subset of rules 235.

### II.5.3.5.2 Ruleset

The Price Model 550 respects the following rules.
(1) Flow price conditions [FP:UCG].
(2) Block Bids.
   (a) In-The-Money [BK:ITM].
(3) Flexible Bids.
   (a) In-The-Money [FX:ITM].
(4) Optimization Goals
   (a) Price Minimization [OT:PMN] or [OT:PMD]

### II.5.3.6 Volume Model

### II.5.3.6.1 Definition

Finally, if in a particular area and hour the calculated price is on a quantity discontinuity on both, the buy and sell curve, the calculated hourly net quantity does not correspond to a unique difference of the buy and the sell quantity components.

The rules of the Volume Model 560 are specific implementations of rules of the third subset of rules 235.

### II.5.3.6.2. Ruleset

The rules of the volume model 560 are quite trivial. The net quantity and the price is fixed.
(1) Optimization Goals
   (a) Maximization Of Executed Volume [OT:VMX].

### II.6 Mathematical Modeling

### II.6.1 Continuous Model

First, buy and sell hourly bids are accumulated into a net bid curve, ζ_{a,h}=ζ_{a,h,B}⊕ζ_{a,h,S}. Also, the hourly quantities are netted as φ_{a,h}=φ_{a,h,B}+φ_{a,h,S}. The contribution of the hourly bids to the socio-economic welfare ω_{a,h}=ω_{a,h,B}+ω_{a,h,S} then accumulates into

$${ω}_{a , h} ( {π}_{a , h} ) = {\int }_{{π}_{a , h}}^{{p}_{a}^{+}} d {ζ}_{a , h} . \qquad ( 6.1 .1 )$$

### II.6.1.1 Definition

The Continuous Model 520 is defined. Indices, if not used in sums, are understood as follows, aεA,hεH,bεB,fεF,a→bεI. The model variables are

Clearing Price π_{a,h} (6.1.2a)

Net Hourly Bid Quantity φ_{a,h} (6.1.2b)

Block Bid Execution 0≦β_{b}≦1 (6.1.2c)

Flexible Bid Execution 0≦β_{f,h}≦1 (6.1.2d)

Quantity Export/Import φ_{a→b,h},φ_{a←b,h} (6.1.2e)

Flow 0≦ρ_{a→b,h} (6.1.2f)

The socio-economic welfare objective is composed as follows

$$\begin{matrix} Ω = {\sum }_{{a ∈ A}_{h ∈ H}}^{ } {Ω}_{a , h} \\ where & ( 6.1 .3 ) \\ {Ω}_{a , h} = {\int }_{{π}_{a , h}}^{{p}_{a}^{+}} d {ζ}_{a , h} + {\sum }_{b ∈ {B}_{a}}^{ } {β}_{b} {q}_{b , h} ( {p}_{b} - {π}_{a , h} ) + {\sum }_{f ∈ {F}_{a}}^{ } {β}_{f , h} {q}_{f} ( {p}_{f} - {π}_{a , h} ) + {\sum }_{b ∈ A}^{ } ( - {π}_{a , h} {ϕ}_{a \to b , h} - {π}_{b , h} {ϕ}_{b ← a , h} ) & ( 6.1 .4 )\end{matrix}$$

with the linear constraints

$$\begin{matrix}\begin{matrix} Hourly & ( {π}_{a , h} , {ϕ}_{a , h} ) ∈ {ζ}_{a , h}\end{matrix} & ( 6.1 .5 ) \\ \begin{matrix} Flexone & 0 \leq {\sum }_{h ∈ H} {β}_{f , h} \leq 1\end{matrix} & ( 6.1 .6 ) \\ Balance 0 = {ϕ}_{a , h} + {\sum }_{b ∈ {B}_{a}} {β}_{b} {q}_{b , h} + {\sum }_{f ∈ {F}_{a}} {β}_{f , h} {q}_{f} + {\sum }_{b ∈ A} ( {ϕ}_{a -> b , h} + {ϕ}_{a ← b , h} ) & ( 6.1 .7 ) \\ \begin{matrix} Deadband & {ϕ}_{a -> b , h} = {ρ}_{a -> b , h} , {ϕ}_{a ← b , h} = - {η}_{a , b} {ρ}_{b -> a , h}\end{matrix} & ( 6.1 .8 ) \\ \begin{matrix} Net Flow & {\overline{ρ}}_{a -> b , h} = {ρ}_{a -> b , h} - {ρ}_{b -> a , h}\end{matrix} & ( 6.1 .9 ) \\ \begin{matrix} ATC & {f}_{a -> b , h}^{-} \leq {ρ}_{a -> b , h} \leq {f}_{a -> b , h}^{+}\end{matrix} & ( 6.1 .10 ) \\ \begin{matrix} Ramping & {\overline{ρ}}_{a -> b , h} - {\overline{ρ}}_{a -> b , h - 1} \leq {r}_{a , b}\end{matrix} & ( 6.1 .11 )\end{matrix}$$

The remaining conditions are modeled as quadratic constraints.

$$\begin{matrix}\begin{matrix}Block ITM & {β}_{b} {\sum }_{h ∈ H} {q}_{b , h} ( {p}_{b} - {π}_{a , h} ) \geq 0 & ∀ b ∈ {B}_{a}\end{matrix} & ( 6.1 .12 ) \\ \begin{matrix}Flex ITM & {β}_{f , h} {q}_{f} ( {p}_{f} - {π}_{a , h} ) \geq 0 & ∀ f ∈ {F}_{a}\end{matrix} & ( 6.1 .13 ) \\ \begin{matrix}Flowprice & \begin{matrix}( {ρ}_{a -> b , h}^{+} - {\overline{ρ}}_{a -> b , h} ) ( {π}_{a , h} - {η}_{a , b} {π}_{b , h} ) \geq 0 \\ ( {ρ}_{a -> b , h}^{-} - {\overline{ρ}}_{a -> b , h} ) ( {π}_{a , h} - {η}_{a , b} {π}_{b , h} ) \geq 0 \\ ( {f}_{a -> b , h}^{+} - {ρ}_{a -> b , h} ) ( {π}_{a , h} - {η}_{a , b} {π}_{b , h} ) \geq 0 \\ ( {f}_{a -> b , h}^{-} - {ρ}_{a -> b , h} ) ( {π}_{a , h} - {η}_{a , b} {π}_{b , h} ) \geq 0\end{matrix}\end{matrix} \\ where \\ {ρ}_{a -> b , h}^{+} = min ( {\overline{ρ}}_{a -> b , h - 1} + {r}_{a , b} , {\overline{ρ}}_{a -> b , h + 1} + {r}_{a , b} ) \\ {ρ}_{a -> b , h}^{-} = max ( {\overline{ρ}}_{a -> b , h - 1} - {r}_{a , b} , {\overline{ρ}}_{a -> b , h + 1} - {r}_{a , b} ) & ( 6.1 .14 )\end{matrix}$$

### II.6.1.2 Socio-Economic Welfare

It turns out to be useful to rewrite the socio-economic welfare. Per area and hour, the contribution of the hourly bids may be transformed to the objective by means of eq. (A.3.3) as

$${ω}_{a , h} ( {ϕ}_{a , h} ) = {\int }_{{ϕ}_{a , h}^{-}}^{{ϕ}_{a , h}} d {ζ}_{a , h}^{- 1} - {π}_{a , h} {ϕ}_{a , h} + {p}_{a}^{+} {ϕ}_{a , h}^{-} \qquad ( 6.1 .15 )$$

Surprisingly, the overall socio-economic welfare does not explicitly depend on the prices. In fact, collecting all terms with factor π_{a,h} gives a contribution of

$$- {π}_{a , h} ( {ϕ}_{a , h} + {\sum }_{b ∈ {B}_{a}} {β}_{b} {q}_{b , h} + {\sum }_{f ∈ {F}_{a}} {β}_{f , h} {q}_{f} + {\sum }_{b ∈ A} ( {ϕ}_{a -> b , h} + {ϕ}_{a ← b , h} ) ) \qquad ( 6.1 .16 )$$

to Ω_{a,h} which vanishes by virtue of the balance equation (6.1.7). In total the socio-economic welfare per hour and area thus reduces to

$${Ω}_{a , h} = {\int }_{{ϕ}_{a , h}^{-}}^{{ϕ}_{a , h}} d {ζ}_{a , h}^{- 1} + {\sum }_{b ∈ {B}_{a}} {β}_{b} {q}_{b , h} {p}_{b} + {\sum }_{f ∈ {F}_{a}} {β}_{f , h} {q}_{f} {p}_{f} + {p}_{a}^{+} {ϕ}_{a , h}^{-} . \qquad ( 6.1 .17 )$$

The last constant term in eq. (6.1.15) can be disregarded in the maximization process.

### II.6.2 Relaxation Model

### II.6.2.1 Definition

The Relaxation Model 530 is defined as follows. For indices aεA,hεH,bεB, fεF,a→bεI and sεS the variables

0≦δₛ≦1(Fill)

0≦β_{b}≦1(Block)

0≦β_{f,h}≦1(Flex)

0≦ρ_{a→b,h}(Flow)

are defined.

The objective function is given by

$$Γ = {\sum }_{\begin{matrix}a ∈ H \\ h ∈ H\end{matrix}} {Γ}_{a , h}^{hrl} + {Γ}_{a , h}^{block} + {Γ}_{a , h}^{flex} \\ {Γ}_{a , h}^{hrl} = {\sum }_{s ∈ {S}_{a , h}} {σ}_{s} ( {δ}_{s} ) \\ {Γ}_{a , h}^{block} = {\sum }_{b ∈ {B}_{a}} {β}_{b} {q}_{b , h} {p}_{b} \\ {Γ}_{a , h}^{flex} = {\sum }_{f ∈ {F}_{a}} {β}_{f , h} {q}_{f} {p}_{f} \\ with \\ {σ}_{s} ( {δ}_{s} ) = \frac{{δ}_{s}}{2} ( {q}_{s} - {q}_{s + 1} ) ( ( 2 - {δ}_{s} ) {p}_{s + 1} + {δ}_{s} {p}_{s} ) \qquad ( Obj )$$

subject to the constraints

$$\begin{matrix}0 \leq {\sum }_{h ∈ H} {β}_{f , h} \leq 1 \\ {ϕ}_{a , h}^{-} + {\sum }_{s ∈ {S}_{a , h}} {δ}_{s} ( {q}_{s} - {q}_{s + 1} ) & ( Flexone ) \\ + {\sum }_{b ∈ {B}_{a}} {β}_{b} {q}_{b , h} + {\sum }_{f ∈ {F}_{a}} {β}_{f , h} {q}_{f} \\ + {\sum }_{b ∈ A} ( {ρ}_{a -> b , h} - {η}_{a , b} {ρ}_{b -> a , h} ) = 0 & ( Balance ) \\ {f}_{a -> b , h}^{-} \leq {ρ}_{a -> b , h} \leq {f}_{a -> b , h}^{+} & ( ATC ) \\ {ρ}_{a -> b , h} - {ρ}_{b -> a , h} - {ρ}_{a -> b , h - 1} + {ρ}_{b -> a , h - 1} \leq {r}_{a , b} & ( Ramping )\end{matrix}$$

The problem of maximizing the socio-economic welfare objective Γ under the constraints eqs. (Flexone) to (Ramping) will be called Relaxation Problem for short.

### II.6.2.2 Solution Properties

In what follows, one maximal solution of the Relaxation Problem is calculated. The variable values of that solution have the values \hat{δ}ₛ, \hat{β}_{b}, \hat{β}_{f,h} and \hat{ρ}_{a→b,h}.

### II.6.2.2.1 Fill Property

### Definition 6.1.

A solution of the Relaxation Problem satisfies the fill property if the fill variable subsets {\hat{δ}ₛ|sεS_{a,h}} satisfy the fill property (A.1) for each area aεA and hour hεH separately.

### 6.1. Proposition.

The Relaxation Problem defined in section II.6.2.1 is considered. There exists a solution \hat{δ}ₛ, \hat{β}_{b}, \hat{β}_{f,h}, \hat{ρ}_{a→b,h} maximizing the socio-economic welfare objective which satisfies the fill condition Definition 6.1.

For solutions that satisfy the fill condition Definition 6.1, the active index ŝ_{a,h} is defined as the active index given in Definition A.1 in the respective area and hour. For convenience, all active indices of a solution are collected in the set

Ŝ={ŝ_{a,h}|aεA,hεH}. (6.2.1)

This indexset can be split according to a quantity or price discontinuity at the corresponding segment. Ŝ^{↓}=Ŝ∩S^{↓} names the set of active indices at quantity discontinuities, and Ŝ^{→}=Ŝ∩S^{→} denotes the set of active indices at price discontinuities.

A consequence of the fill property is that the quantity \hat{φ}_{a,h} and the price variables \hat{π}_{a,h} can be rewritten. Applying eq. (A.5.4) of Proposition A.2 per area and hour it is found

$${\hat{ϕ}}_{a , h} = {q}_{{\hat{s}}_{a , h} + 1} + {\hat{δ}}_{{\hat{s}}_{a , h}} ( {q}_{{\hat{s}}_{a , h}} - {q}_{{\hat{s}}_{a , h} + 1} ) = {ϕ}_{a , h}^{-} + {\sum }_{s ∈ {S}_{a , h}} {\hat{δ}}_{s} ( {q}_{s} - {q}_{s + 1} ) \\ {\hat{π}}_{a , h} = {p}_{{\hat{s}}_{a , h} + 1} - {\hat{δ}}_{{\hat{s}}_{a , h}} ( {p}_{{\hat{s}}_{a , h} + 1} - {p}_{{\hat{s}}_{a , h}} ) = {p}_{a}^{+} - {\sum }_{s ∈ {S}_{a , h}} {\hat{δ}}_{s} ( {p}_{s + 1} - {p}_{s} ) \qquad ( 6.2 .2 )$$

and the pair (\hat{π}_{a,h},\hat{φ}_{a,h}) is on the bid curve ζ_{a,h}.

Furthermore, by Proposition A.2, the welfare integral is represented by the sum

$${\int }_{{ϕ}_{a , h}^{-}}^{{ϕ}_{a , h}} d {ζ}_{a , h}^{- 1} = {\sum }_{s ∈ {S}_{a , h}} {σ}_{s} ( {δ}_{s} ) \qquad ( 6.2 .3 )$$

### II.6.2.2.2 In-The-Money Property

### 6.2. Proposition.

An optimal solution of the Relaxation Problem which satisfies the fill property Definition 6.1 also fulfills the in-the-money rules [BK:ITM] and [FX:ITM] corresponding to the quadratic constraints specified in eq. (6.1.13) and eq. (6.1.12).

### II.6.2.2.3 Flow Price Property

### 6.3. Proposition.

An optimal solution of the Relaxation Problem satisfying the fill property Definition 6.1 also satisfies the flow-price rule [FP:UCG] corresponding to the quadratic constraints of eq. (6.1.14).

### II.6.2.2.4 Model Equivalence

### 6.4. Proposition.

The Relaxation Problem defined in section II.6.2.1 is considered. There exists an optimal solution of the Relaxation Problem which satisfies the rules of the Continuous Model 520 and the optimal objective Γ maximizes the socio-economic welfare Ω.

Proof. The proof is fairly simple, as only results already derived need to be collected.
(1) As shown in Proposition 6.1 there is an optimal solution of the Relaxation Problem which satisfies the fill property Definition 6.1.
(2) By the consequence eq. (6.2.3) of Proposition 6.1, the hourly bid curve integral of the socio-economic welfare (6.1.17) coincides with the sum over the segment integrals in (Obj) for each area and hour.
(3) By the consequence eq. (6.2.2) of Proposition 6.1, the hourly quantity on the bid curve in eq. (6.1.7) equals the hourly quantity contribution in the balance condition constraint (Balance). Moreover, the calculated prices and quantities per area and hour are on the bid curve.
(4) By the flow-price property Proposition 6.3, the solution respects the flow-price rule [FP:UCG] modeled by the constraints eq. (6.1.14).
(5) By virtue of the in-the-money property Proposition 6.2, the rules [BK:ITM] and [FX:ITM] for block and flexible bids represented by the constraints eqs. (6.1.12) and (6.1.13) are automatically satisfied.

This proves the equivalence.

### II.6.2.3 Uniqueness

It is started with an optimal solution of the Relaxation Problem which satisfies the fill property Definition 6.1.

Firstly, not all fill variables δₛ are subject to model constraints, or appear in the objective function. In fact, the socio-economic welfare contributions from the hourly terms σₛ(δₛ) and the summands δₛ (qₛ−qₛ₊₁) in the balance condition vanish at a price discontinuity since there qₛ=qₛ₊₁. The objective is thus independent of the value of the variables δₛ for sεS^{→}. Part of these variables is fixed by the fill condition when both adjacent values are one or zero resp. The remaining variables which correspond to active indices remain undetermined. These are the variables δₛ with index sεŜ^{→}. This indeterminacy is exploited to fix the prices in agreement with the flow price conditions in the price determination phase.

Secondly, the objective is not explicitly dependent on the flow variables ρ_{a→b,h} which only appear in the constraints eqs. (Balance) to (Ramping) of the model. That property may be used to choose a solution with minimal flows.

There is also a more general ambiguity which covers the flow ambiguity. Suppose a solution contained one non-integral fill variable 0<\hat{δ}ₛ<1 at the active index sεŜ_{a,h}^{↓} in an area a and hour h in a quantity discontinuity. Since there pₛ=pₛ₊₁, the contribution to the welfare objective function reduces to σₛ (δₛ)=pₛ(qₛ−qₛ₊₁)δₛ. Suppose furthermore the solution contained a second active index t also at a quantity discontinuity in the same hour but in a different area b with tεŜ_{b,h}^{↓}. Then the objective contains the sum of the terms

pₛ(qₛ−qₛ₊₁)δₛ+pₜ(qₜ−qₜ₊₁)δₜ (6.2.4)

The sum of these terms is constant if either pₛ=η_{a,b}pₜ̂ρ_{b→a,h}=0 or pₜ=η_{a,b}pₛ̂ρ_{a→b,h}=0 or pₜ=pₛ̂η_{a,b}=1.

To see that, one might rewrite the balance condition by inserting the solution for the execution variables \hat{β}_{b}, \hat{β}_{f,h} and the flows \hat{ρ}_{u→v,h} for all interconnectors u→vεI\{a→b}. Concerning area a, the expression δₛ(qₛ−qₛ₊₁)+ρ_{a→b,h}−η_{a,b}ρ_{b→a,h} must be constant. On the other hand, the balance condition for area b requires that δₜ(qₜ−qₜ₊₁+ρ_{b→a,h}−η_{a,b}ρ_{a→b}) be constant. Adding these expressions multiplied by pₛ and pₜ respectively proves the conjecture.

In summary, suppose one optimal solution of the Relaxation Model 530 is found with variable values \hat{δ}ₛ, \hat{ρ}_{a→b,h} and \hat{β}_{b}, \hat{β}_{f,h}. Terms referring to active indices of segments which are quantity discontinuities are collected. For those area and hour index pairs (a,h)εA×H which correspond to an element ŝ_{a,h}εŜ^{↓}, the binding to the solution values is relaxed for fill variables 0≦δ_{ŝ}_{_{a,h}}≦1 and the flows ρ_{a→b,h}≧0 and the following equations are considered

$$\begin{matrix} {\sum }_{s ∈ {\hat{S}}^{↓}} {p}_{s} ( {q}_{s} - {q}_{s + 1} ) {δ}_{s} = \tilde{Γ} & ( {Objective}^{′} ) \\ ( {q}_{{\hat{s}}_{a , h}} - {q}_{{\hat{s}}_{a , h} + 1} ) {δ}_{{\hat{s}}_{a , h}} + {\sum }_{b ∈ A} ( {ρ}_{a -> b , h} - {η}_{a , b} {ρ}_{b -> a , h} ) + {\tilde{ϕ}}_{a , h} = 0 & ( {Balance}^{′} )\end{matrix}$$

as well as the constraints (ATC) and (Ramping) with the constants

$$\begin{matrix}\tilde{Γ} = {\sum }_{s ∈ {\hat{S}}^{↓}} {p}_{s} ( {q}_{s} - {q}_{s + 1} ) {\hat{δ}}_{s} & ( 6.2 .5 ) \\ {\tilde{ϕ}}_{a , h} = {q}_{{\hat{s}}_{a , h} + 1} + {\sum }_{b ∈ {B}_{a}} {\hat{β}}_{b} {q}_{b , h} + {\sum }_{f ∈ {F}_{a}} {\hat{β}}_{f , h} {q}_{f} . & ( 6.2 .6 )\end{matrix}$$

The objective function of a solution of the Relaxation Problem remains unchanged for bindings of the flows ρ_{a→b,h} and the fill variables δ_{ŝ}_{_{a,h}} consistent with the system of the in(-equalities) eqs. (Objective′), (Balance′), (ATC) and (Ramping). This ambiguity will be fixed in the flow determination step.

### II.6.3 Flow Model

The Flow Model input data is based on a solution of the Welfare Model 510, which—by the Proposition 6.4—is equivalent to a solution of the Relaxation Problem. The variables net hourly executed quantity φ_{a,h} and the execution variables β_{b} and β_{f,h} are fixed to the solution values.

However, as outlined in Section II.6.2.3, flows are in general not unique. In particular, as the objective function does not explicitly depend on the flow variables ρ_{a→b,h} one may vary these values without changing the objective as long as the constraints balance, ATC and ramping are still satisfied. Specifically, as long as the net flow—import minus export—per market area is kept fixed, the value of the socio-economic welfare does not change for different routings of the flows.

A simple Flow Model 540 determines the flows corresponding to the rule [OT:FLN] or rule [OT:FQU] but does not exploit the additional freedom to vary the fill variables δₛ for sεŜ^{↓}. For indices hεH,a→bεI the remaining model variables are only the flows ρ_{a→b,h}≧0 subject to the net flow constraint

$$\begin{matrix}{Balance}^{″} & {\sum }_{b ∈ A} ( {ρ}_{a -> b , h} - {η}_{a , b} {ρ}_{b -> a , h} ) + {{ϕ}^{\tilde{\sim}}}_{a , h} = 0\end{matrix} \qquad ( 6.3 .1 )$$

together with the constraints (ATC) and (Ramping) where

$${{ϕ}^{\tilde{\sim}}}_{a , h} = {\hat{ϕ}}_{a , h} + {\sum }_{b ∈ {B}_{a}} {\hat{β}}_{b} {q}_{b , h} + {\sum }_{f ∈ {F}_{a}} {\hat{β}}_{f , h} {q}_{f} . \qquad ( 6.3 .2 )$$

The objective to be minimized is the sum

$${\sum }_{{a -> b ∈ I}_{h ∈ H}} {ρ}_{a -> b , h} \qquad ( 6.3 .3 )$$

for the linear flow minimization market rule [OT:FLN], and

$${\sum }_{{a -> b ∈ I}_{h ∈ H}} {ρ}_{a -> b , h}^{2} \qquad ( 6.3 .4 )$$

for the quadratic variant rule [OT:FQU]. However, a generalized version of the simple Flow Model is used in the flow determination step later.

### II.6.4 Price Model

The price model 550 is build on a solution of the Relaxation Problem satisfying the Definition 6.1, where the values for the flows or \hat{ρ}_{a→b,h} and the execution variables \hat{β}_{b}, \hat{β}_{f,h} have been fixed.

Additionally, all fill variables are fixed by the solution, the fill property and the flow determination process, except for those at active indices at price discontinuities. These are the fill variables δₛ with indices sεŜ^{→}.

According to Definition 6.1 the prices are given by the expression π_{a,h}=p_{ŝ}_{_{a,h}}₊₁−(p_{ŝ}_{_{a,h}}₊₁−p_{ŝ})δ_{ŝ}_{_{a,h}}. For hours and areas, where the fill variables are completely determined, this fixes also the clearing price.

The variables of the Price Model 550 are given by π_{a,h}, δ_{ŝ} with aεA,hεH and ŝεŜ^{→}. They are subject to the price equations

π_{a,h}=p_{ŝ}_{_{a,h}}₊₁−(p_{ŝ}_{_{a,h}}₊₁−p_{ŝ}_{_{a,h}})δ_{ŝ}_{_{a,h}} (6.4.1)

for areas and hours where ŝ_{a,h}εŜ^{→}. For all other areas and hours where ŝ_{a,h}εŜ\Ŝ^{→}, the prices are determined by the constants

π_{a,h}=p_{ŝ}_{_{a,h}}₊₁−(p_{ŝ}_{_{a,h}}₊₁−p_{ŝ}_{_{a,h}})δ_{ŝ}_{_{a,h}}. (6.4.2)

Furthermore, for pairs of areas a,bεA, the flow-price rule [FP:UCG] now requires the conditions

π_{a,h}≧η_{a,b}π_{b,h} if \overline{\hat{ρ}}_{a→b,h}<\hat{ρ}_{a→b,h}̂\hat{ρ}_{a→b,h}<f_{a→b,h}⁺ (6.4.3)

π_{a,h}≦η_{a,b}πb,h if \hat{ρ}_{a→b,h}⁻< \overline{\hat{ρ}}_{a→b,h}̂f_{a→b,h}⁻<\hat{ρ}_{a→b,h} (6.4.4)

with the definitions eqs. (4.2.4) and (4.2.5).

Moreover, one has to be sure not to violate the rules [BK:ITM] and [FX:ITM] for block and flexible bids. The additional condition to be satisfied for blocks and flexible bids that are in-the-money are

$${\sum }_{h ∈ H}^{ } {q}_{b , h} ( {p}_{b} - {π}_{a , h} ) \geq 0 \\ ∀ a ∈ A , b ∈ {B}_{a} \\ if \\ {\hat{β}}_{b} > 0 \qquad ( 6.4 .5 )$$

and

q_{f}(p_{f}−π_{a,h})≧0∀fεF,hεH if \hat{β}_{f,h}>0. (6.4.6)

The objectives for the price model are

$${\sum }_{{\hat{s}}_{a , h} ∈ {\hat{S}}^{\to }}^{ } ( {p}_{{\hat{s}}_{a , h}} - {p}_{{\hat{s}}_{a , h}} + 1 ) {δ}_{{\hat{s}}_{a , h}} \qquad ( 6.4 .7 )$$

for rule [OT:PMN] and

$${\sum }_{{\hat{s}}_{a , h} ∈ {\hat{S}}^{\to }}^{ } {( {p}_{{\hat{s}}_{a , h} + 1} - {p}_{{\hat{s}}_{a , h}} )}^{2} {( 2 {δ}_{{\hat{s}}_{a , h}} - 1 )}^{2} \qquad ( 6.4 .8 )$$

in case of market rule [OT:PMD]. The objective should be minimized subject to the constraints eqs. (6.4.1) to (6.4.6).

### II.7 Solution Strategy

### II.7.1 Socio-Economic Welfare Maximization

### II.7.1.1 Algorithm Outline

The solution strategy for the Welfare Model 510 is outlined here, the substeps are discussed in detail in the following Sections. This a specific embodiment of FIG. 1.

The basic idea is to take advantage of hierarchy sketched in the II.6. Suppose one wants to find a solution of the Welfare Model 510 for given input data, then the following steps are performed.
(1) The Hourly bid curves are extended (section II.7.1.2).
(2) An instance of the Relaxation Model 530 is constructed using the given input data.
(3) The model is solved using the Multibranch Algorithm specified in section II.7.1.3. The algorithm returns a solution of the Welfare Model 510 accounting for the following reasoning.
   (a) A solution of the Relaxation Model 530 optimizes the quadratic welfare objective.
   (b) By the equivalence property Proposition 6.4, and by the optimality of the solution, the subset of rules giving rise to quadratic constraints in the Continuous Model 520 are automatically satisfied such that the solution of Relaxation Problem is automatically a solution of the Continuous Model 520.
   (c) If other rules of the Welfare Model 510 are violated, additional cuts are generated by the algorithm and included as additional constraints in the Relaxation Model 530.
   (d) If a solution of the Relaxation Problem requires no further cuts, it satisfies all rules of the Welfare Model 510. The solution is thus a potential optimal solution candidate of the Welfare Model 510.
   (e) The algorithm permutates over all emerging cuts and selects the welfare maximal candidate among the solutions of the Welfare Model 510.

Mathematically, the solution returned by the Multibranch Algorithm is not guaranteed to be optimal. On the other hand, in many cases it turned out to deliver optimal or close to optimal results. In practice the calculation time is limited. It is often desired to deliver good results within the limited time, rather than to incur the risk of a long-running calculation to produce an optimality-proven result. A trade-off between the runtime of the calculation and the quality of the result has to be made. A statistical evaluation of real-live data has proven that the Multibranch Algorithm is an extremely efficient way to deal with this challenge.

### II.7.1.2 Bid Curve Extension

In order to obtain the input of the Relaxation Model 530, the original input market data may be modified by extending the hourly bid curves ζ. The resulting modified curves ζ̅ are defined by the modified set of interpolation points C̅. The following issues can be dealt with directly by a suitable extension of the bid curves.
The curtailment of hourly bids, rule [CA:HLY].
The rule [CA:NDG] demanding that curtailment should not degrade intrinsic curtailment if such a condition is required for a particular area.
Minimal and maximal area prices deviating from the global price range limits.

### II.7.1.2.1 Curtailment Extension

In order to handle the curtailment of hourly bids in an integrated way, the hourly bid curves are extended by adding interpolation points.

In a first step the extremal quantities are determined. Depending on the market model three cases can appear.
There is no rule [CA:NDG] defined for a selected area. Then by the general curtailment rule [CA:HLY] for hourly bids, the bid curves may be curtailed completely in all hours in that area.
The rule [CA:NDG] is in power for an area, but there is no intrinsic curtailment in a particular hour of that area. In this case curtailment of the corresponding hourly buy and sell bids is forbidden.
The rule [CA:NDG] is required in an area which contains a bid curve in an hour that exhibits intrinsic curtailment. There, the actual curtailment is restricted by the intrinsic curtailment factor of that hour.

Mathematically, the sell curve can be extended to the maximum quantity q_{a,h,S}^{↑} given by

$${q}_{a , h , S}^{↑} = \{ \begin{matrix}{\overline{γ}}_{a , h , S} {ϕ}_{a , h , S}^{+} & if [ CA \text{:} NDG ] in a \\ 0 & otherwise\end{matrix} \qquad ( 7.1 .1 )$$

If the first interpolation point of the sell curve has not already the maximum allowed value, a point with minimum price and extended quantity is prepended to the bid curve.

∀aεA,hεH:

q_{a,h,s}⁺≠q_{a,h,S}

[symbol]

C̅_{a,h,S}←((pₐ⁻,q_{a,h,S}^{↑}))∪C_{a,h,S} (7.1.2)

Similarly, the curtailed buy curve may drop down to

$${q}_{a , h , B}^{↓} = \{ \begin{matrix}{\overline{γ}}_{a , h , B} {ϕ}_{a , h , B}^{-} & if [ CA \text{:} NDG ] in a \\ 0 & otherwise\end{matrix} \qquad ( 7.1 .3 )$$

If the last interpolation point of the buy curve differs from this value, a point with maximum price and minimal curtailed quantity has to be appended to the bid curve.

∀aεA,hεH:

q_{a,h,B}⁻≠q_{a,h,B}^{↓}

[symbol]

C̅_{a,h,B}←C_{a,h,B}∪((pₐ⁺,q_{a,h,B}^{↓})) (7.1.4)

### II.7.1.2.2 Price Range Extension

In order to deal with differing price ranges of market areas, the already curtailment-extended hourly bid curves are extended to the global minimum and maximum prices with constant quantity.

At the minimum price one performs

∀aεA,hεH:

pₐ⁻≠p⁻

[symbol]

C̅_{a,h,B}←((p⁻,q_{a,h,B}⁺))∪ C̅_{a,h,B}

C̅_{a,h,S}←((p⁻,q_{a,h,S}^{↑})∪ C̅_{a,h,S} (7.1.5)

At the maximum price the bid curves are modified as follows

∀aεA,hεH:

pₐ⁺≠p⁺

[symbol]

C̅_{a,h,B}← C̅_{a,h,B}∪((p⁺,q_{a,h,B}^{↓}))

C̅_{a,h,S}← C̅_{a,h,S}∪((p⁺,q_{a,h,S}⁻)) (7.1.6)

### II.7.1.3 Multibranch Algorithm—An Embodiment of Method 100

### II.7.1.3.1 Overview

The quadratic Welfare Model is solved by the so-called Multibranch Algorithm. The basic idea is to solve a series of relaxed optimization problems by successively adding particular constraints the socalled cuts (the term cut is used in general for any condition that is violated in the relaxation, but must be satisfied in the original problem. In the literature, cut mostly denotes an additional condition that is required to produce integer an solution) until the relaxed problem including the cuts satisfies all properties of the original Welfare Model 510. A cut when actually incorporated into the Relaxation Model 530 turns into a constraint for the intermediate optimization. This problem, i.e. the Relaxation Problem including a number of cuts is thus called Cut Relaxation Problem (CRP).

In general, a solution of the Welfare Model 510 obtained by successively adding cuts depends on the order the cuts are applied. For example, consider a relaxation problem R, and suppose further that the algorithm calculates the set of cuts {v₀,v₁, v₂} for the relaxation. The algorithm strategy is to restrict R step by step. One may start off adding the first constraint v₀, which generates the subproblem R∪{v₀}. If the solution is not a solution of the Welfare Model 510, one might continue by adding the second cut giving rise to the derived problem R∪{v₀,v₁}. If the solution is still not compatible with the rules of the Welfare Model 510, one might proceed to add the last cut. The generated subproblem including all three cuts by chance solves the Welfare Model 510. So, one ends up with a chain R→R∪{v₀}→R∪{v₀,v₁}→R∪{v₀,v₀v₂} as the intermediate subproblems are not a solution of the Welfare Model 510. On the other hand, consider the alternative to add the cuts in a different order, R→R∪{v₁}→ . . . . Occasionally it might happen that already the intermediate solution R′=R∪{v₁} solves the Welfare Model. In that case, however, the algorithm stops after the subproblem R′.It is concluded that in order to browse as many as possible solution candidates for the Welfare Model all permutations of cuts need to be considered.

The algorithm includes the following procedures.
Cutting—embodiment of step 135 of FIG. 1. Given a solution of a CRP, this procedure determines the set of conditions of the Welfare Model 510 that are still violated. The procedure then generates a set of additional cuts that need to be added to the Relaxation Model 530.
Bounding. The bounding procedure keeps track of an upper and lower bound for the overall optimization objective.
Pruning embodiment of step 140 of FIG. 1. The pruning procedure marks solutions of

CRP which can be safely discarded from the search for the optimal solution. It also keeps track of the currently best solution candidate for the Welfare Model 510, and implicitly calls the bounding procedure.
Search—embodiment of steps 145 and 165 of FIG. 1. The search strategy determines which CRP should be considered next in the cut and branch generation. It implicitly calls the branching procedure generating subordinated CRPs. If the procedure is successful, it returns a new CRP.
Branching—embodiment of steps 420 to 430 of FIG. 4. The branching procedure generates a set of child-problems of a solved CRP with known cuts.

### II.7.1.3.2 Main Steps

The algorithm keeps track of a current active problem.
(1) Preparation—embodiment of step 120 of FIG. 1.
   The Relaxation Model 530 is constructed for the given input data. This is the initial problem. The current active problem is set to the initial problem.
(2) Solve—embodiment of step 130 of FIG. 1.
   The active problem is solved. The output is the active solution.
(3) Pruning—embodiment of step 140 of FIG. 1.
   The pruning procedure is called with the active solution as input.
(4) Cutting—embodiment of step 135 of FIG. 1.
   The cutting procedure is called on the active solution. It generates a set of cuts corresponding to the active solution.
(5) Search—embodiment of steps 145 and 165 of FIG. 1.
   The searching algorithm is performed with the active solution as input. If the search returns a new CRP, this is the new active problem, and the algorithm continues with item 2. Otherwise, the searching procedure is repeated with the initial problem as input. If the repeated search returns a new CRP, this is the new active problem, and the algorithm continues with item 2.
(6) Result—step 180 of FIG. 1.
   The result is the current best solution candidate tracked by the pruning procedure.

### II.7.1.3.3 Nodes

The Multibranch Algorithm entails solving a number of subproblems organized in nodes. Each node v represents a quadratic optimization problem consisting of the relaxation problem (6.2.1) together with a set of c additional constraints T={τ₀, τ₁, . . . , τ_{c-1}}. The set of additional constraints is an embodiment of the set of additionally selected constraints described with regard to FIGS. 1 to 4. Unsolved nodes are defined by their set of constraints only, and will be denoted as v=(T|.).

Having solved the CRP, the optimal objective Γ is known, Γ has been referred to as solution in the general overview section. Moreover, checking values of the model variables, the cut generation procedure may find a number of violated rules. These give rise to a set of y additional cuts Y={v₀, v₁ . . . , v_{y-1}}, which has been referred to as the set of possible cuts in the general overview section.

A solved node v is thus characterized by the set of applied constraints T and the set of possible cuts Y. For bookkeeping purposes, one also keeps track of the set of cuts Z which may be used to generate new branches, called branch generators or simply generators. Z has been referred to as set of cuts to be examined in the general overview section. The set of generators is always a subset of the cuts, Z⊂Y. Cuts from the set Z are consumed step by step in the branching procedure. As a notational convention, nodes are denoted by tuples of the set of constraints, the objective value, the set of cuts as well as the set of generators, v=(T|Γ;Y;Z).

If a node is solved, but the branching has not yet been performed on it then the set of generators is initialized to the set of all cuts; newly calculated nodes are given by (T|Γ;Y;Y).

In general, nodes can be pruned by simply removing all elements from the node's set of generators resulting in v=(T|Γ;Y;{ }).

If the cut generation procedure finds that the set of cuts is empty, then the solution of the CRP by definition also satisfies all rules of the Welfare Model 510. Nodes with Y=Z={ } require no further cutting, and are solution candidates for the Welfare Model 510. Such solutions can easily be identified by an empty set of cuts (T|Γ;{ };{ }).

Finally, nodes which have no solution of the assigned CRP are written as (T|-).

Nodes are organized in a directed graph. The predecessor-successor relation is established by the branching procedure as described below.

### II.7.1.3.4 Branching Embodiment of Steps 420 to 435 of FIG. 4

Suppose there already exists a graph G=(N,E) of subproblems with n nodes N={v₀, v₁ . . . , vₙ₋₁} and a number of arcs E⊂N×N.

The procedure starts off with a solved generating node v of the graph G, adds an arc, and returns the destination node of the arc.

Suppose the generating node v=(T|Γ;Y;Z)εN has a non-empty set of generators, Z≠{ }. One removes one generator v e Z from the set of the generating cuts, v←(T|Γ;Y;Z\{v}) and reconsiders the problem additionally constraint by this cut. In case one applies the cut that would generate a derived node v′=(T′|Γ′;.) with the more restrictive set of constraints T′=T∪{v} and non-higher objective value Γ′≦Γ. Depending on the set T′, two cases have to be separated.

∃v″εN|v″=(T′|.).
There already exists an other node v″ in the graph for the derived set of constraints T′. In this case, only an arc v [symbol] v″ is added to the edges E of the graph. The returned node is v″.

∀(T″|.)εN|T″≠T′.
For every node in the graph, the set of constraints is distinct from the set of constraints of the derived node. In such cases, one adds the derived node v′ to the graph G and adds the arc v [symbol] v′ linking the generating and the derived node to the set of edges E. The returned node is v′.

Note that the set of cuts Y′ of the derived node is in general not identical with the reduced set of generating cuts Z\{v}.

### II.7.1.3.5 Graph

By definition, the seed for the generation of the branching graph is the Relaxation Model 530. The initial node ({ }|.) is called root node and by definition contains no additional constraints. A graph G generated by the branching rules has the following properties.
For any pair of directly linked nodes (T|Γ;.) [symbol] (T′|Γ′;.), the set of the constraints of the source node is a proper subset of the set of constraints of the target node, T⊂T′. Also, the objective value of the derived node is not larger than the objective value of the generating node, ⊖′≦Γ.
The graph is a directed acyclic graph. The graph defines a partial order ≦ on the nodes where v≦v′ exactly when there exists a directed path from v to V′.

### II.7.1.3.6 Bounding

Bounding means to keep track of a lower and upper bound of the optimization objective. Since one is dealing with a maximization problem being tightened successively by adding constraints, the upper bound is identical to the objective value of the uncut Relaxation Problem. If the root node was found to be ({ }|Γ₀;.), then Γ≦Γ₀ for all other nodes with objective value Γ being branched off from the root node.

At the start of the Multibranch Algorithm, the lower bound of the maximal objective is initialized to minus infinity Γ⁻=−∞ since its value is unknown. During the procedure, this value is increasing.

The global maximal objective value of a solution of the underlying Welfare Model must be in the interval, Ωε[Γ⁻,Γ₀].

### II.7.1.3.7 Pruning Embodiment of Step 140 of FIG. 1

The pruning procedure keeps track of the current best solution candidate v*=(T*|Γ*;{ };{ }) and checks, if newly created nodes can be disregarded. Before starting the branching procedure, no solution candidate is known, and the current best solution is marked as non-existent by ∃/v*. Suppose furthermore that some node v=(T|Γ;Y;Y) has just been calculated. Then, several cases have to be distinguished.
Y={ }
The new node satisfies the Welfare Model 510 and is a solution candidate. The following cases have to be considered.
   ∃/v*.
   There is no current best solution known so far. So the current best node is set to the newly calculated node, v*←v. The lower bound of the bounding interval is updated to the new best objective value, Γ⁻=Γ.
   ∃v*̂Γ>Γ*.
   There is a current best solution, but the new node has better objective value than the current best node. The current best node is set to the new node, v*←v.
   The entire set of nodes N must be checked for pruning. All nodes (T′|Γ′;Y′;Z′)εN with Γ′<Γ are pruned; their set of generators is emptied by setting Z′={ }. The lower bound of the bounding interval is updated to the improved objective value, Γ⁻=Γ.
Y≠{ }̂∃v*̂Γ<Γ*
The new node is not a solution candidate, there exists a current best solution candidate, and the new node cannot improve the objective. Then the node v should be pruned v←(T|Γ;Y;{ })
Otherwise.
No pruning action is performed in all other cases.

### II.7.1.3.8 Searching Embodiment of Steps 145 and 165 of FIG. 1

The searching procedure determines which node should be considered next for the calculation. The general strategy applied is to perform a depth-first search. The procedure expects node v̅ as input. On entry, it is supposed that the input node v̅ has already been evaluated—the associated CRP has been solved, and—in case there exists a solution—the cuts have been calculated. Then, the procedure returns a new node for further calculation, or nothing if direct or indirect descendants in the graph have already been calculated and no new branches could be generated in the post-ordinated subgraph. In particular the following steps are performed.
(1) If the input node is terminal, v̅=(T|Γ;{ }; { }), nothing is performed, and the procedure returns.
(2) If the input node has no solution, v=(T|-), nothing is performed, and the procedure returns.
(3) Suppose the input node v̅=(T|Γ;Y;Z) has the set of generators Z. The following steps are repeated as long as the set of generators is non-empty, Z≠{ }.
   3.1. The branching procedure is performed on the input node, with result v′=Branch( v̅). The result is examined.
   3.2. If the resulting node v′ is an unsolved node, branching was successful. Then the new node v′ is the outcome and the procedure returns.
(4) At this point, as the input node v̅=(T|Γ;Y;Z) has no generators left, Z={ }, the set D of linked descendants is considered, D={v′εN| v̅ [symbol] v′}. For each element v′ in the set of descendants, the following steps are performed.
   4.1. The searching procedure is called recursively on V′, with result v″=Search(v′).
   4.2. If the outcome of the call returns an unsolved node, the resulting node is v″ and the procedure returns.
(5) The procedure could not generate an unsolved node. It returns.

### II.7.1.3.9 Cutting Embodiment of Step 135 of FIG. 1

Cut generation deals with violated conditions of the Welfare Model 510. A violation gives rise to one or more additional constraints that must be imposed on the variables of the Relaxation Model 530. One cut may in general encompass one or more conditions on the model variables.

### II.7.1.3.9.1 General Considerations and Strategy

According to the all-or-nothing condition for block bids, the execution variables must be constraint to integral values. The standard branch and bound procedure would require to include two alternative cuts, namely set the execution parameter to either zero or one. However forcing block or flexible bids to be included by explicitly setting the corresponding execution variable to one destroys the equivalence property Proposition 6.4 between the Relaxation Model 530 and the Continuous Model 520.

In particular, fixing the execution variable to one has the consequence of violating the fill condition for the fill variables (equivalent to a violation of the hourly full execution). This condition had to be re-introduced explicitly by means of integral auxiliary variables in the Relaxation Model 530.

Loosing the automatic fill property of the Relaxation Model 530 has the consequence that the included block and flexible bids are no longer automatically in-the-money. Again, that condition had to be enforced by explicitly adding in-the-money constraints in the Relaxation Model 530 as well.

Additionally, also the flow-price conditions are no longer automatically satisfied. So also these had to be included explicitly.

So, one ends up with a number of additional constraints, and a bunch of integral variables. The solution of this extended model in turn requires a branching procedure as a subprocess. Although one could follow that approach, the inclusion of block or flexible bids complicates the model to a large extend with the consequence of degrading calculational performance.

The strategy applied here is a different one. Only cuts with execution variables set to zero are considered. This has the advantage that excluded block and flexible bids do not imply additional in-the-money conditions. Of course, one may miss branches which eventually yield higher objective value. In practice, however, it turns out that these cases are rare.

To illustrate this fact in more detail, it is conjectured that a solution equivalent to an optimal solution of the Welfare Model 510 can be obtained only by excluding a particular set of block and flexible bids from the Relaxation Model 530. Natural candidates for the exclusion list are subsets of the set of non-integer execution variables in the solution of the Relaxation Model 530. The solution strategy applied here follows that idea. The Relaxation Model 530 is constraint and resolved step-by-step, where for each iteration one additional cut is introduced for a non-integral value of an execution variable.

Note that a proof of optimality would also require to consider block and flexible bids with execution variable values of one in the exclusion list.

### II.7.1.3.9.2 Cutting Rules

Cuts are tagged by the violated rule of the Welfare Model 510 with the corresponding relaxed rule in the Relaxation Model 530, if such a rule exists. The formal description of the cut is similar to the definition introduced for market rules.

∀ Indexset:

Preconditions

[symbol] Cut

where

Cut={ [symbol] Constraint0 [symbol] , [symbol] Constraint1 [symbol] , [symbol] Constraint2 [symbol] , . . . }

The singe cut is a set of constraints. The constraints are (in)-equalities on the model variables. To avoid confusion, each constraint is explicitly enclosed in angle brackets. A cutting rule in general generates a set of cuts, one for each element in the indexset that satisfies the given precondition.

### II.7.1.3.9.3 AON Condition for Block Bids

According to the all-or-nothing condition for block bids, the execution variables must be constraint to integral values. That would require to include two alternative cuts, namely et the execution parameter to either zero or one. However, following our strategy outlined before, only one cut excluding a block bid is applied if the execution variable was non-integral in the result of the parent relaxation model solution.

∀bεB:

0<β_{b}<1(BK:AON [symbol] BK:AON′)

[symbol]

{ [symbol] β_{b}=0 [symbol] }

### II.7.1.3.9.4 Block Links

The rule (II.4.1.2.4) requires the removal of the source block if it is linked to a non-executed destination block.

∀a [symbol] bεL:

β_{b}>0̂β_{b}=0(BK:LNK [symbol] )

[symbol]

{ [symbol] βₐ=0 [symbol] }

### II.7.1.3.9.5 AON Condition for Flexible Bids

According to rule this rule, the relaxation to non-integral execution variables of flexible bids must be constraint to integral values.

∀hεH,fεF:

0<β_{f,h}<1(FX:AON [symbol] FX:AON′)

[symbol]

[symbol]

{β_{f,h}=0 [symbol] }

### II.7.1.3.9.6 No Block Bids in Curtailment

If rule [CA:NBK] is included in the Welfare Model 510, the following cut per curtailed area and hour has to be applied for sell blocks

∀aεA,hεH:

φ_{a,h,S}>φ_{a,h,S}⁺(CA:NBK [symbol] )

[symbol]

{ [symbol] (β_{b}=0 [symbol] |bεBₐ̂q_{b,h}<0}

as well as

∀aεA,hεH:

φ_{a,h,B}<φ_{a,h,B}⁻(CA:NBK [symbol] )

[symbol]

{ [symbol] (β_{b}=0 [symbol] |bεBₐ̂q_{b,h}>0}

for curtailment buy hours.

### II.7.1.3.9.7 No Im- or Export for Curtailment

The rule [CB:NIE] together with the rule [FW:DBN] requires to suppress flow if it would degrade curtailment. In case of curtailment sell, flow into the curtailed hour is forbidden

∀a→bεI,hεH:

φ_{a,h,S}>φ_{a,h,S}⁺(CB:NIEF [symbol] )

[symbol]

{ [symbol] ρ_{b→a,h}=0 [symbol] }

whereas for curtailment buy, it is demanded that the export be zero

∀a→bεI,hεH:

φ_{a,h,B}<φ_{a,h,B}⁻(CB:NIE [symbol] )

[symbol]

{ [symbol] ρ_{a→b,h}=0 [symbol] }

### II.7.1.3.9.8 Cut Relaxation Model—Embodiment of Current Model of Method 100

Cuts to the Relaxation Model do not corrupt the hierarchical dependency of the optimization models presented in section II.5.2.3.

First, it is observed that adding cuts to the Relaxation Model 530 does not alter the objective function. Secondly, it is essential that all cuts defined herein can be implemented in the Relaxation Model 530 by modifications of the input data and do not alter the structure of the model definition section II.6.2.1.

In particular, implementing the conditions [symbol] β_{b}=0 [symbol] and [symbol] β_{f,h}=0 [symbol] simply boils down to remove the block bid or the flexible bid completely from the model. Furthermore, restrictions on flows like [symbol] ρ_{a→b,h}=0 [symbol] are taken into account by reducing the corresponding ATC limit to zero, f_{a→b,h}→0.

If the solution is considered as an optimal candidate of the Welfare Model 510, and a price determination is performed then the reduced ATC value must be taken into account in the flow-price condition eqs. (6.4.3) and (6.4.4) of the model.

Accordingly, all solution properties discussed in section II.6.2.2 also apply if the Relaxation Model 530 is supplemented by cuts. Thus, also a solution of the CRP is equivalent to a solution of the Continuous Model 520 if supplemented by the same cuts as the Relaxation Model 530.

Moreover, if there are no more cuts required by the market rules, the solution of the cut Relaxation Problem is furthermore equivalent to a solution of the Welfare Model 510.

### II.7.1.4 Improvements

A number of amendments have been implemented to further improve calculational performance.

### II.7.1.4.1 Price-Equal Block Bids

Block bids with equal limit prices and proportional quantities can be implemented more efficiently as described here. Details are not given in this specification.

### II.7.1.4.2 Quantity-Equal Block Bids

The algorithm can be improved for subsets of block bids with equal quantity. Details are not given in this specification.

### II.7.1.4.3 Flexible Bids

The cutting rule for flexible bids can modified to improve calculational performance. Details are not given in this specification.

### II.7.2. Flow Determination

The simple Flow Model is a non integer linear respectively quadratic optimization problem which can be solved quickly enough by standard methods. However, the non-uniqueness of the solution discussed in Section II.6.2.3 can be exploited further to minimize flows and to implement the curtailment rule [CB:SPD] in a single step. If the curtailment rule is required for any area pairs, and the solution of the Relaxation Model 530 shows curtailment, this rule should take precedence over the flow minimization.

Specifically, if the solution has market areas with curtailment in an hour hεH at buy or sell side zε{B,S}

A_{h,z}={aεA|γ_{a,h,z}<1}

then in this hour, on any connector

I_{h,z}={a→b|a,bεA_{h,z}}

the rule of spreading of curtailment [CB:SPD] should apply.

In order to integrate this condition, the curtailment factors for buy and sell sides from the net quantity based Relaxation Model need first to be expressed. Taking into account the monotony property of the hourly bid curves, in case of curtailment buy the sell quantity can be replaced by its minimum φ_{a,h,S}⁻ at the maximal area price. Analogously, for curtailment sell situations the buy quantity is given by the maximum φ_{a,h,B}⁺.

Putting that together with the definition of the net quantity, φ_{a,h}=φ_{a,h,B}+φ_{a,h,S} and the definition of the curtailment factors eqs. (4.3.1) and (4.3.2) one gets

γ_{a,h,B}=(φ_{a,h}−φ_{a,h,S}⁻)/φ_{a,h,B}⁻, (7.2.1)

γ_{a,h,S}=(φ_{a,h}−φ_{a,h,B}⁺)/φ_{a,h,S}⁺ (7.2.2)

with

φ_{a,h}=q_{ŝ}_{_{a,h}}₊₁+(q_{ŝ}_{_{a,h}}−q_{ŝ}_{_{a,h}}₊₁)δ_{ŝ}_{_{a,h}} (7.2.3)

which represents the hourly quantity in terms of the active fill variable.

Depending on the input data, it might not always be possible to spread curtailment completely among neighboring curtailed areas. Therefore one might include a quadratic term (γ_{a,h,z}−γ_{b,h,z})² per hour and buy and sell side for pairs of areas a,bεI_{h,z} in the objective function. This term minimizes to zero if complete spreading is possible on the connector a→b.

The extended flow minimization model can be summarized as follows. The model variables are the flows ρ_{a→b,h}≧0 for all interconnectors a→bεI and hours hεH and the fill variables 0≦δ_{ŝ}_{_{a,h}}≦1 with sεŜ^{↓} subject to the constraints eqs. (Objective′) to (Ramping) as well as the definitions eqs. (7.2.1) to (7.2.3). The objective to be minimized is given by

$${\sum }_{{h ∈ H}_{a \to b ∈ I \text{/} ( {I}_{h , B} U {I}_{h , S} )}}^{ } {ρ}_{a -> b , h}^{k} + {\sum }_{{h ∈ H}_{{z ∈ \{ B , S \}}_{a \to b ∈ {I}_{h , z}}}}^{ } {( {γ}_{a , h , Z} - {γ}_{b , h , z} )}^{2} \qquad ( 7.2 .4 )$$

The exponent k depends on the flow rule applied and is chosen to be one for the linear model [OT:FLN] and two for the quadratic model [DT:FOU]. The problem can be solved by standard optimization methods.

### II.7.3 Price Determination

Also, the Price Model is a non integer linear [OT:PMN] or quadratic [OT:PMD] optimization problem. In practice, standard methods are performing well enough such that no particular algorithms are necessary. The price determination is performed by solving the Price Model 550, with the modification that the cuts generated by [CB:NIE-] in the Multibranch Algorithm of section II.7.1.3 have to be merged into the ATC limit parameters f_{a→b,h}⁻ and f_{a→b,h}⁺.

Having calculated the result of the price optimization problem, one has to guarantee that the resulting prices are within the permissible price range of the market area. That may not always be the case since the bid curves have been extended to the global minimal and maximal prices. Suppose, the price optimization returns the values π_{a,h}, then one adjusts the prices as follows

$${\hat{π}}_{a , h} = \{ \begin{matrix}{p}_{a}^{-} & if & {π}_{a , h} \leq {p}_{a}^{-} \\ {π}_{a , h} & if & {p}_{a}^{-} < {π}_{a , h} < {p}_{a}^{+} \\ {p}_{a}^{+} & if & {p}_{a}^{+} \leq {π}_{a , h}\end{matrix} . \qquad ( 7.3 .1 )$$

Note that if the price has to be moved to within the area's price range, the flow-price rule [FP:UCG] my be violated with respect to the non-extended price range.

### II.7.4 Volume Determination

Volume determination has to be performed for hours, where the net executed hourly quantity cannot be uniquely split into buy and sell components. This can happen if the active segment of the solution is in a quantity discontinuity. Since prices and net quantities are already fixed, the volume maximization can be done separately per area and hour. Suppose that the net quantity determined by the previous optimizations is found to be (hour and area indices are dropped) 0. Then, it is asked for a decomposition

\hat{φ}=φ_{B}+φ_{S} (7.4.1)

Also, the hourly execution price has been fixed in the price optimization step to be \hat{π}. Then, there is an ambiguity if there are buy bid curve interpolation points (p_{i,B},q_{i,B}), (p_{i+1,B},q_{i+1,B}) and sell curve interpolation points (p_{j,S},q_{j,S}), (p_{j+1,S},q_{j+1,S}) such that both p_{i,B}=p_{i+1,B}=\hat{π} and p_{j,S}=p_{j+1,S}=\hat{π}. The buy and sell components must thus be within the bounds

q_{i,B}≦φ_{B}≦q_{i+1,B} and q_{j,S}≦φ_{S}≦q_{j+1,S}. (7.4.2)

Accounting for (7.4.1), the sell quantity is given by φₛ=\hat{φ}−φ_{B}. Consequently, the maximization objective φ_{B}−φ_{S}=2φ_{B}−\hat{φ} is Optimized by Maximizing φ_{B} Subject to

q_{i,B}≦φ_{B}≦q_{i+1,B}\hat{φ}−q_{j,S}≧φ_{B}≧\hat{φ}−q_{j+1,S}. (7.4.3)

The solution is can be read off directly as and

φ_{B}=min(q_{i+1,B},\hat{φ}−q_{j,S}) and φ_{S}=min(\hat{φ}−q_{i+1,B},q_{j,S}). (7.4.4)

### II.7.5 Rule Implementation Summary

For completeness, it is summarized where and how the market rules are implemented in the solution process.

| Group | Rule/Implementation Strategy |
|---|---|
| Hourly | Full Execution (FUL) |
| Bids (HY) | By construction included in the fill variable model of the bid |
| | curve (appendix A.4), together with the fill property of the |
| | Relaxation Model (Proposition 6.1). |
| Block | All-Or-Nothing (AON) |
| Bids | A cut on the Relaxation Model, [BK: AON-BK: AON′]. |
| (BK) | All-Or-Nothing Relaxation (AON′) |
| | Constraint in the Relaxation Model, eq. (Block) |
| | In-The-Money (ITM) |
| | Property of solutions of the Relaxation Problem, |
| | (Proposition 6.2). |
| | Block Links (LNK) |
| | A cut on the Relaxation Model, [BK: LNK-] |
| Flexible | All-Or-Nothing (AON) |
| Bids (FX) | A cut on the Relaxation Model, [FX: AON-FX: AON′] |
| | All-Or-Nothing Relaxation (AON′) |
| | Constraints in the Relaxation Model, eqs. (Block) and |
| | (Flexone). |
| | In-The-Money (ITM) |
| | Property of solutions of the Relaxation Model, (Proposition |
| | 6.2). |
| Flow | ATC Limits (ATC) |
| Con- | Constraint in the Relaxation Model, eq. (ATC) |
| straints | Ramping (RMP) |
| (FW) | Constraint in the Relaxation Model, eq. (Ramping) |
| | Deadband (DBN) |
| | Integrated in the constraint eq. (Balance) in the Relaxation |
| | Model. |
| Flow- | Uncongested Flow (UCG) |
| Price | Property of solutions of the Relaxation Problem, |
| Conditions | (Proposition 6.3) |
| (FP) | |
| Area | Curtailment Of Hourly Bids (HLY) |
| Curtail- | Integrated in the curtailment extension of the bid curves, |
| ment | section II.7.1.2.1. |
| Rules | No Block Bids In Curtailment (NBK) |
| (CA) | A cut on the Relaxation Model, [CA: NBK-] |
| | Block Bid Conversion (CNV) |
| | Implemented as a meta-rule. If convertible blocks need to |
| | be converted according to rule (II.4.3.1.3) in a solution of the |
| | Welfare Model, they are converted, and the Welfare Model |
| | is resolved from scratch based on the modified input data. |
| | Non-Degradation Of Curtailment (NDG) |
| | Integrated in the curtailment extension of the bid curves, |
| | section II.7.1.2.1. |
| Bilateral | No Im- or Export For Curtailment (NIE) |
| Curtail- | A cut on the Relaxation Model, [CB: NIE-] |
| ment | Spreading Of Curtailment Sell (SPD) |
| Rules | Implemented in the extended flow determination step. |
| (CB) | |
| Balance | Area Balance (ARA) |
| (BC) | Constraint in the Relaxation Model, eq. (Balance) |
| Optimiza- | Maximization Of Socio-Economic Welfare (WLF) |
| tion | The objective function of the Relaxation Model, eq. (obj). |
| Goals | The correctness of this model is guaranteed by the |
| (OT) | Proposition 6.4. |
| | Linear Flow Minimization (FLN) |
| | Objective function in eq. (7.2.4) with k = 1. |
| | Quadratic Flow Minimization (FQU) |
| | Objective function in eq. (7.2.4) with k = 2. |
| | Linear Minimum Price Rule (PMN) |
| | Objective function in eq. (6.4.7). |
| | Quadratic Minimum Price Rule (PMD) |
| | Objective function in eq. (6.4.8). |
| | Volume Maximisation (VMX) |
| | The volume maximisation requirement is explicitly solved by |
| | eq. (7.4.4). |

### APPENDIX A

### Bid Curves

### A.1 Interpolation Points

A bid curve is defined by a list of n pairwise distinct interpolation price-quantity pairs, C=((pᵢ,qᵢ)|0≦i<n), with prices pᵢ and quantities qᵢ. The elements (pᵢ|qᵢ) of the interpolation point list must be ordered by increasing prices and by decreasing quantities. Specifically, if the price-quantity pair (pᵢ|qᵢ) comes before(pⱼ|qⱼ) in the list, i<j, then its components must satisfy both pᵢ≦pⱼ and qᵢ≧qⱼ.

Bid curves should not contain three consecutive points on a line. In particular, one must not include the middle point of) (pᵢ₋₁|qᵢ₋₁)→(pᵢ|qᵢ)→(pᵢ₊₁|qᵢ₊₁) if either pᵢ₋₁=pᵢ=pᵢ₊₁ or qᵢ₋₁=qᵢ=qᵢ₊₁. By convention, a bid curve that contains only non-negative (non-positive) quantities, is called buy (sell) curve.

### A.2 Definition

The bid curve itself is the set of all price-quantity pairs that can be obtained by linearly interpolating between two adjacent interpolation points. In particular, two price-quantity pairs (pᵢ|qᵢ) and (pᵢ₊₁|qᵢ₊₁) define bid curve points (p|q) with coordinates

pᵢ≦p≦pᵢ₊₁,qᵢ≧q≧qᵢ₊₁ (A.2.1)

satisfying

(p−pᵢ)(qᵢ₊₁−qᵢ)=(q−qᵢ)(pᵢ₊₁−pᵢ). (A.2.2)

For short, one writes for a solution in segment i of the defining equation eq. (A.2.2) (p,q)εζᵢ and ζᵢ is called the i^{th} segment relation. Three cases can be separated.
Inclined segment pᵢ<pᵢ₊₁ and qᵢ₊₁<qᵢ. Within these segments, the bid curve points (p,q) define a linear invertible function of the price, to with

ζᵢ:p [symbol] q=qᵢ+(p−pᵢ)(qᵢ₊₁−qᵢ)/(pᵢ₊₁−pᵢ) (A.2.3)

and

ζᵢ⁻¹:q [symbol] p=pᵢ+(q−qᵢ)(pᵢ₊₁−pᵢ)/(qᵢ₊₁−qᵢ). (A.2.4)
Quantity discontinuity p=pᵢ=pᵢ₊₁ and q≧qᵢ≧qᵢ₊₁. The segment relation is not a function. Nevertheless, the inverse relation defined by

ζᵢ⁻¹:q [symbol] pᵢ (A.2.5)
is a constant function.
Price discontinuity pᵢ≦p≦pᵢ₊₁ and q=qᵢ₊₁=qᵢ. The segment relation is the constant function

ζᵢ:p [symbol] qᵢ (A.2.6)
but the inverse relation does not define a function.

### A.3 Integration

Let ζᵢ with 0≦i<n−1 be the n−1 segment relations of a bid curve with n interpolation points. Furthermore, let (p,q) with pₖ≦p<pₖ₊₁ and qₖ₊₁≦q<qₖ be a point on the bid curve in segment k which is not a quantity discontinuity. Then the integral over the bid curve is defined as a sum of Riemann integrals over segment functions for segments which are not quantity discontinuities

$${\int }_{p}^{{p}_{n - 1}} d ζ := {\int }_{p}^{{p}_{k + 1}} {ζ}_{k} ( {p}^{′} ) d {p}^{′} + {\sum }_{{k < i < n - 1}_{{p}_{i} \neq {p}_{i + 1}}}^{ } {\int }_{{p}_{i}}^{{p}_{i + 1}} {ζ}_{i} ( {p}^{′} ) d {p}^{′} . \qquad ( A .3 .1 )$$

Similarly, one defines the integral over the inverse bid curve as integral of the inverted segment functions over all non price-discontinuity intervals

$${\int }_{{q}_{n - 1}}^{q} d {ζ}^{- 1} := {\int }_{{q}_{k + 1}}^{q} {ζ}_{k}^{- 1} ( {q}^{′} ) d {q}^{′} + {\sum }_{{n - 1 > i > k}_{{q}_{i} \neq {q}_{i + 1}}}^{ } {\int }_{{q}_{i + 1}}^{{q}_{i}} {ζ}_{i}^{- 1} ( {q}^{′} ) d {q}^{′} .$$

### A.1. Corollary.

The integrals eqs. (A.3.1) and (A.3.2) are related by

$${\int }_{p}^{{p}_{n - 1}} d ζ = {\int }_{{q}_{n - 1}}^{q} d {ζ}^{- 1} - pq + {p}_{n - 1} {q}_{n - 1} . \qquad ( A .3 .3 )$$

Proof. First suppose that (p,q) is in an inclined segment where p and q are linearly dependant. Differentiation of (A.3.3) by p leads to

$$- {ζ}_{k} ( p ) = \frac{d q}{d p} {ζ}_{k}^{- 1} ( q ) - q - p \frac{d q}{d p} \qquad ( A .3 .4 )$$

which is an identity since ζₖ(p)=q and ζₖ⁻¹(q)=p.

Secondly, suppose that (p,q) is in a quantity discontinuity. There, the price is constant p=pₖ, and q independent of p. The differential of (A.3.3) with respect to q leads to

0=ζₖ⁻(q)−pₖ (A.3.5)

which meets the definition of the inverse for a quantity discontinuity.

Third, consider the case where (p,q) lies in a price discontinuity. Correspondingly, one may set q=qₖ, and consider p as independent variable.

Differentiation of (A.3.3) with respect to p leads to

−ζₖ(p)=−qₖ (A.3.6)

which is true by definition.

Finally, setting p=pₙ₋₁ and q=qₙ₊₁ shows that also the constant term is correct.

### A.4 Fill Variable Model

A bid curve with n≧2 interpolation points may be modeled by introducing n−1 fill variables 0≦δᵢ≦1 with 0≦i<n−1 for each segment of the fill curve. The variable interpolates the quantity q in the range qᵢ₊₁≦q≦qᵢ by

q=qᵢ₊₁+δᵢ(qᵢ−qᵢ₊₁) (A.4.1)

For non price-discontinuity segments, the inverse bid curve can be expressed directly from the definition eq. (A.2.2) in terms of the fill variable,

δᵢ⁻¹(q)=pᵢ₊₁−δᵢ(pᵢ₊₁−pᵢ) (A.4.2)

The integral over the segment i is given by

$$\begin{matrix}\begin{matrix}{σ}_{i} ( {δ}_{i} ) = {\int }_{{q}_{i + 1}}^{q} {ζ}_{i}^{- 1} ( {q}^{′} ) d {q}^{′} \\ = ( {q}_{i} - {q}_{i + 1} ) {\int }_{0}^{{δ}_{i}} ( {p}_{i + 1} - \tilde{δ} ( {p}_{i + 1} - {p}_{i} ) ) d \tilde{δ} \\ = \frac{{δ}_{i}}{2} ( {q}_{i} - {q}_{i + 1} ) ( ( 2 - {δ}_{i} ) {p}_{i + 1} + {δ}_{i} {p}_{i} )\end{matrix} & ( A .4 .3 ) \\ & ( A .4 .4 ) \\ & ( A .4 .5 )\end{matrix}$$

In case the integration is over the whole segment, δᵢ=1, the upper bound of the integral reaches the i-th quantity, q=qᵢ, and the integral is the area of the orthogonal trapezoid

$${σ}_{i} ( 1 ) = {\int }_{{q}_{i + 1}}^{{q}_{i}} {ζ}_{i}^{- 1} ( {q}^{′} ) d {q}^{′} = \frac{1}{2} ( {q}_{i} - {q}_{i + 1} ) ( {p}_{i} + {p}_{i + 1} ) \qquad ( A .4 .6 )$$

whereas the integral over the segment vanishes for fill variable values of zero,

σᵢ(0)=0. (A.4.7)

Note that the expression (A.4.3) is even defined for price discontinuities with qᵢ=qᵢ₊₁. There, however, the integral σᵢ(δᵢ) vanishes for any values of the fill variable.

### A.5 Fill Property

An important feature fill variables may satisfy is the so-called fill property.

### Definition A.1.

A set of fill variables δᵢ with indices 0≦i<n−1 satisfies the fill property if either there exists an index k in the range 0≦k<n−1 such that for

$$\begin{matrix}{δ}_{k} > 0 \\ and \\ {δ}_{i} = \{ \begin{matrix}0 & for & 0 \leq i < k \\ 1 & for & k < i < n - 1\end{matrix} \\ or & ( A .5 .1 ) \\ {δ}_{i} = 0 \\ for all \\ 0 \leq i < n - 1 & ( A .5 .2 )\end{matrix}$$

The index k is called the active index of the variable set δᵢ.

Obviously, the property implies δᵢ≦δᵢ₊₁ for 0≦i<n−2.

### A.2. Proposition.

Consider a bid curve with n interpolation points C=((pᵢ,qᵢ)|0≦i<n). If a set of the fill variables δᵢ with 0≦i<n−1 satisfies the fill property Definition A.1 with active index k, and (p, q) with p=pₖ₊₁−δₖ(pₖ₊₁−pₖ) and q=qₖ₊₁+δₖ(qₖ−qₖ₊₁) represents a price-quantity pair in the segment k on the bid curve, then

$$\begin{matrix}{\int }_{{q}_{n - 1}}^{q} d {ζ}^{- 1} = {\sum }_{n - 1 > i \geq 0}^{ } {σ}_{i} ( {δ}_{i} ) \\ and & ( A .5 .3 ) \\ p = {p}_{n - 1} - {\sum }_{n - 1 > i \geq 0}^{ } {δ}_{i} ( {p}_{i + 1} - {p}_{i} ) & ( A .5 .4 ) \\ q = {q}_{n - 1} + {\sum }_{n - 1 > i \geq 0}^{ } {δ}_{i} ( {q}_{i} - {q}_{i + 1} ) . & ( A .5 .5 )\end{matrix}$$

### APPENDIX B

### Notations and Conventions

Lowercase Latin letters are used for input data quantities, as e.g. q_{b,h} and p_{b} for the block bid hourly quantities and limit price. Lowercase Greek letters are model variables, as e.g. φ and π for quantity and price variables, or ρ for flows. The calculated values for variables x are marked by \hat{x}. Minimal and maximal values of a variable x of a set are marked by x⁻ and x⁺, respectively.

### B.1 Input Data

Summary of the notations for market input data.

TABLE 1
Market data input quantities

| Symbol | Meaning |
|---|---|
| H | Timely sorted list of delivery hours. For hours |
| | h ∈ H, h − 1 denotes the predecessor, and |
| | h + 1 the successor. |
| A | Set of market areas. |
| pₐ⁻, pₐ⁺ | Minimum and maximum price of market area a. |
| C_{a, h, {B, S}} | Buy (B) and sell (S) bid curves interpolation point |
| | lists in market\| area a and hour h. |
| q_{a, h{B, S}}⁺, | Maximum and minimum quantity of hourly buy |
| q_{a, h{B, S}}⁻ | (B) and sell (S) bid in market area a and hour h. |
| B, Bₐ | The indexset labelling all block bids; The |
| | indexset labelling all block bids in market |
| | area a. |
| p_{b}, q_{b, h} | Limit price and quantity parameter of hour h |
| | of block bid b. |
| L | The set of pairs of blocks that represent block |
| | links a → b. |
| F, Fₐ | The indexset labelling all flexible bids; |
| | The indexset labelling the flexible bids in |
| | market area a. |
| p_{f}, q_{f} | Limit price and quantity parameter of flexible |
| | bid f. |
| f_{a→b, h} | ATC parameter for flows from market area a to |
| | market area b in hour h. |
| ^{r}_{a, b} | Ramping parameter on interconnectors a [symbol] b. |
| η_{a, b} | Dead-band parameter on interconnectors a [symbol] b. |

Summary of the notations for model variables.

TABLE 2
Market coupling model variables

| Symbol | Meaning |
|---|---|
| π_{a, h} | Price in market area a in hour h. |
| ρ_{a→b, h}, ρ̅_{a→b, h} | Directed flow a → b in hour h; Net flow in |
| | direction a → b for hour h. |
| φ_{a, h, {B, S}}, φ_{a, h} | Hourly buy (B) and sell (S) bid quantity in market |
| | area a at hour h; Hourly net quantity in area a at |
| | hour h. |
| φ_{a→b, h}, φ_{a←b, h} | Exported quantity from area a to area b in hour h; |
| | Imported quantity into area a from area b in hour h. |
| π_{b}, φ_{b, h} | Execution price and executed quantity in hour h of |
| | block bid b. |
| π_{f}, φ_{f, h} | For a flexible bid f, the execution price and executed |
| | quantity in hour h. |
| β_{b}, β_{f, h} | Execution variable for a block bid with index b; |
| | Execution variable for a flexible bid with index f |
| | in hour h. |
| γ_{a, h, {B, S}} | Curtailment factor buy and sell in area a and hour h. |

The present invention may be operational with numerous general purpose or special purpose computing systems environments or configurations. Examples of well known computing systems, environments and/or configurations that may be suitable for use with the invention may include, but are not limited to, personal computers, server computers, handheld or laptop devices, embedded systems, multi-processor systems, micro-processor based systems, network PCs, mini-computers, tablet computers, smartphones, mainframe computers, distributed computing environments that include any of the above system or devices, and the like.

The invention may be described in the general context of computer-executable instructions, such as program modules, being executed by a computer. Generally, program modules include routines, programs, objects, components, data structures, et cetera that perform particular tasks or implement particular abstract data types. The general purpose or special purpose computing system environments or configurations may be programmable using a high level computer programming language. In some embodiments, the general purpose or special purpose computing system environments or configurations may also use specially programmed, special purpose hardware.

As already mentioned, the invention may also be practices in distributed computing environments where tasks are performed by remote processing devices that are linked through a communication network. In a distributed computing environment, program modules may be located in both local and remote computer storage media including memory storage devices.

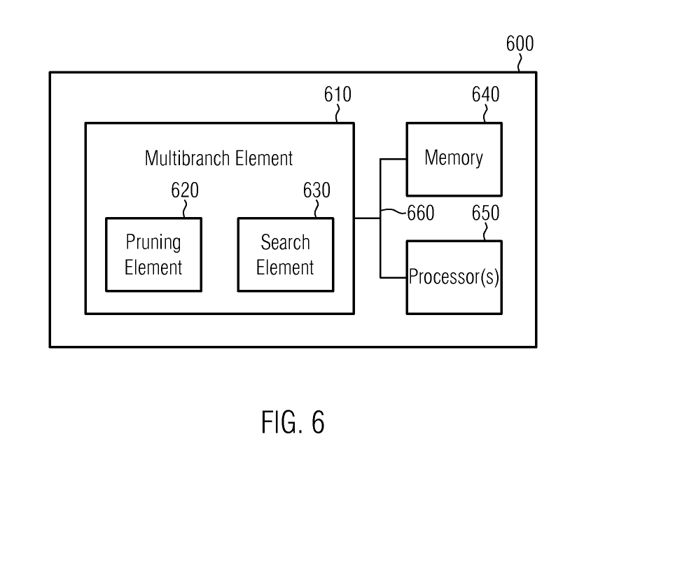

FIG. 6 illustrates a computer architecture 600 for carrying out the methods disclosed with respect to FIG. 1, FIG. 3 and FIG. 4. The computer architecture may include one or more computing devices having one or more processors 650. Instructions are recorded on tangible media and are executed by the one or more processors 650 to carry out the disclosed functions. The architecture includes a multibranch element 610 and a memory 640. The multibranch element 610 may further include a pruning element 620 and/or a search element 630. All three elements 610, 620 and 630 communicate with memory 640 and the one or more processors 650 via bus 660. The steps of FIG. 1 are performed by multibranch element 610. The steps of FIG. 3 are performed by pruning element 620. The steps of FIG. 4 are performed by search element 630.

While the invention has been described with respect to the physical embodiments constructed in accordance herewith, it will be apparent to those skilled in the art that various modification, variation and improvements of the present invention may be made in the light of the above teachings and within the purview of the appended claims with out departing from the spirit and intended spirit of the invention. Accordingly, it is to be understood that the invention is not limited by the specific illustrative embodiments, but only by the scope of the appended claims.

1. A computer-implemented method for reducing a computational effort of finding a solution of a first model modeling a real-world scenario, the first model having model variables and being defined by a set of rules comprising a first subset of rules and a second subset of rules, each rule of the set of rules defining at least one condition for at least one model variable, the method comprising:
a) building a set of relaxed rules by relaxing each rule of the first subset of rules of the first model, wherein relaxing a rule comprises modifying at least one condition of said rule;
b) constructing an initial model using the set of relaxed rules and the second subset of rules;
c) computing a solution of the initial model, the solution of the initial model being a set of model variables satisfying each rule of the initial model;
d) for each rule in the first subset of rules: determining if the solution of the initial model satisfies the rule, and if the solution of the initial model does not satisfy the rule, determining a cut for the rule, the cut being a constraint on at least one model variable of the rule, and storing the cut in a set of initial possible cuts of the initial model; and
e) if the set of initial possible cuts of the initial model is empty, storing the solution of the initial model as a solution of the first model.

2. The method of claim 1, further comprising:
f) if the set of initial possible cuts of the initial model is not empty, storing the cuts of the set of initial cuts in a set of cuts to be examined for the initial model, selecting one or more cuts from the set of cuts to be examined for the initial model and removing the selected cuts from the set of cuts to be examined for the initial model;
g) modifying the initial model to a modified current model by constraining the initial model with the one or more selected cuts;
h) setting a current model to the modified current model;
i) if the current model has not been solved yet, computing a solution of the current model, the solution of the current model being a set of model variables satisfying each rule defining the initial model and satisfying each selected cut;
j) for each rule in the first subset of rules: determining if the solution of the current model satisfies the rule, and if the solution of the current model does not satisfy the rule, determining a cut for the rule, the cut being a constraint on at least one model variable of the rule, and storing the cut in a set of current possible cuts of the current model; and
k) if the set of current possible cuts of the current model is empty, storing the solution of the current model as a solution of the first model.

3. The method of claim 2, further comprising:
l) if the set of current possible cuts is not empty, storing the cuts of the set of current possible cuts in a set of cuts to be examined for the current model, selecting one or more cuts from the set of cuts to be examined for the current model and removing the selected cuts from the set of cuts to be examined for the current model;
m) modifying the current model to a modified current model by constraining the current model with the one or more selected cuts from the set of cuts to be examined for the current model;
n) setting the current model to the modified current model of step m); and
o) returning to step i).

4. The method of claim 3, further comprising:
p) if the current model has been solved, setting the current model to the initial model, selecting one or more cuts from the set of cuts to be examined for the initial model and removing the selected cuts from the set of cuts to be examined for the initial model;
q) modifying the current model to a modified current model by constraining the current model with the one or more selected cuts of step p); and
r) if the modified current model has not been solved yet, setting the current model to the modified current model of step q), computing a solution of the current model, and returning to step j).

5. The method of claim 4, wherein storing the solution of the current model as a solution of the first model further comprises:
determining if a solution of the first model has been stored;
if a solution of the first model has been stored, determining if the solution of the current model is better than the stored solution of the first model; and
if the solution of the current model is better than the stored solution of the first model, replacing the stored solution with the solution of the current model.

6. The method of claim 5, further comprising if the solution of the current model is not better than the stored solution, setting the set of cuts to be examined for the current model to the empty set.

7. The method of claim 1, wherein the model variables comprise a subset of execution variables, wherein at least one rule of the first subset of rules defines a condition for at least one execution variable, the condition for the execution variable constraining the execution variable value to an integral number, and wherein relaxing the rule comprises modifying the condition to allow non-integral values for said execution variable.

8. The method of claim 7, further comprising:
if the solution of the initial or current model does not satisfy each rule of the first subset of rules, identifying all execution variables of the solution of the initial or current model which have a non integral value;
for each identified execution variable having a non integral value, generating a constraint which sets the identified execution variable to an integral number; and
adding the generated constraints to the set of initial or current possible cuts.

9. The method of claim 1, wherein the first subset of rules comprises at least one rule which defines at least one condition for a subset of the model variables, the at least one condition for the subset of the model variables constraining model variable values of the subset to satisfy an equality or inequality, and wherein relaxing the at least one rule which defines at least one condition for a subset of the model variables comprises modifying or disregarding said at least one condition for the subset of the model variables.

10. The method of claim 9, further comprising:
for each rule of the first subset of rules:
if the solution of the initial or current model does not satisfy the rule, identifying a set of variables of the solution of the initial or current model, the set of variables comprising variables which have values that do not satisfy at least one condition of the rule;
for each identified set of variables, generating a constraint which restricts the values of the variables of the identified set to satisfy an equality or an inequality of the at least one condition of the rule; and
adding the generated constraint to the set of initial or current possible cuts.

11. A computer-readable medium having computer-executable instructions that, when executed by a computer, cause the computer to perform a method for reducing a computational effort of finding a solution of a first model modeling a real-world scenario, the first model having model variables and being defined by a set of rules comprising a first subset of rules and a second subset of rules, each rule of the set of rules defining at least one condition for at least one model variable, the method comprising:
a) building a set of relaxed rules by relaxing each rule of the first subset of rules of the first model, wherein relaxing a rule comprises modifying at least one condition of said rule;
b) constructing an initial model using the set of relaxed rules and the second subset of rules;
c) computing a solution of the initial model, the solution of the initial model being a set of model variables satisfying each rule of the initial model;
d) for each rule in the first subset of rules: determining if the solution of the initial model satisfies the rule, and if the solution of the initial model does not satisfy the rule, determining a cut for the rule, the cut being a constraint on at least one model variable of the rule, and storing the cut in a set of initial possible cuts of the initial model; and
e) if the set of initial possible cuts of the initial model is empty, storing the solution of the initial model as a solution of the first model.

12. A computer system comprising:
a memory having stored computer-executable instructions; and
a processor configured for executing the stored computer-executable instructions, the computer-executable instructions causing the processor to perform a method for reducing a computational effort of finding a solution of a first model modeling a real-world scenario, the first model having model variables and being defined by a set of rules comprising a first subset of rules and a second subset of rules, each rule of the set of rules defining at least one condition for at least one model variable, the method comprising:
a) building a set of relaxed rules by relaxing each rule of the first subset of rules of the first model, wherein relaxing a rule comprises modifying at least one condition of said rule;
b) constructing an initial model using the set of relaxed rules and the second subset of rules;
c) computing a solution of the initial model, the solution of the initial model being a set of model variables satisfying each rule of the initial model;
d) for each rule in the first subset of rules: determining if the solution of the initial model satisfies the rule, and if the solution of the initial model does not satisfy the rule, determining a cut for the rule, the cut being a constraint on at least one model variable of the rule, and storing the cut in a set of initial possible cuts of the initial model; and
e) if the set of initial possible cuts of the initial model is empty, storing the solution of the initial model as a solution of the first model.
